(19) United States
(12) Patent Application Publication
(10) Pub. No.: US 2014/0062313 A1
(43) Pub. Date: Mar. 6, 2014

(54) LIGHTING DEVICE AND LIGHTING FIXTURE USING THE SAME

(71) Applicant: PANASONIC CORPORATION, Osaka (JP)

(72) Inventors: Atsushi Ootsubo, Osaka (JP); Hiroyuki Matsumoto, Hyogo (JP); Koji Uenoyama, Kyoto (JP)

(21) Appl. No.: 13/877,201

(22) PCT Filed: Oct. 4, 2012
(86) PCT No.: PCT/JP2012/075790

§ 371 Date: Apr. 1, 2013

(30) Foreign Application Priority Data
Oct. 26, 2011 (JP) 2011-234992

(51) Int. Cl. H05B 33/08

(52) U.S. Cl. CPC H05B 33/0857; H05B 33/0872
USPC 315/158; 315/307

(57) ABSTRACT

The lighting device includes a light source unit including a plurality of light emission elements having different color temperatures; and a lighting control unit configured to control the light source unit. The lighting control unit is configured to perform: a first lighting process of supplying a first supply current to a first light emission element group of the plurality of the light emission elements such that the light source unit emits light having a first color temperature; and a second lighting process of supplying a second supply current to a second light emission element group of the plurality of the light emission elements such that the light source unit emits light having a second color temperature different from the first color temperature. The lighting control unit is configured to adjust magnitudes of each of the first supply current and the second supply current such that first luminous flux of the light source unit in the first lighting process is identical to second luminous flux of the light source unit in the second lighting process.

### TECHNICAL FIELD

The present invention relates to lighting devices and lighting fixtures and particularly to a lighting device suitable for a light emitting diode (LED) used as a light source and a lighting fixture using the same.

### BACKGROUND ART

In the past, there has been proposed a lighting device which includes multiple kinds of light sources having different luminescent colors and can change a color of light emitted to a lighting space by use of color mixing process of adjusting (dimming) light outputs of the respective light sources (c.f., e.g., document 1 “JP 2011-49123 A”, paragraphs [0061] to [0068], and FIG. 8).

This lighting device includes a white LED configured to emit white light, a natural white color LED configured to emit light having a natural white color, and a lamp color LED configured to emit light having a lamp color. The lighting device determines light outputs of the respective LEDs in accordance with a control command included in an infrared signal sent from an infrared remote controller. Further, the lighting device can singly turn on any one of the white LED, the natural white color LED, and the lamp color LED.

Generally, when currents with the same magnitude are supplied to plural kinds of light sources having different luminescent colors respectively, the light source with a higher color temperature has higher luminous flux and the light source with a lower color temperature has lower luminous flux. Thus, as for the lighting device disclosed in aforementioned document 1, when currents with the same magnitude are supplied to the LEDs respectively, the white LED with the highest color temperature has the highest luminous flux and the lamp color LED with the lowest color temperature has the lowest luminous flux. Consequently, the luminous flux is decreased when the white LED is turned off and the natural white color LED or the lamp color LED is turned on. Such a decrease in the luminous flux is likely to give feeling of strangeness to a user.

To solve the above problem, there has been proposed a method of increasing the light output of the natural white color LED or the lamp color LED to compensate for a decrease in the luminous flux. In some cases, even when the natural white color LED or the lamp color LED is lit at the maximum light output, it is impossible to compensate for a decrease in the luminous flux.

### SUMMARY OF INVENTION

In view of the above insufficiency, the present invention has aimed to propose a lighting device capable of reducing a change in luminous flux due to switch between luminescent colors and a lighting fixture using the same.

The lighting device of the first aspect in accordance with the present invention includes: a light source unit including a plurality of light emission elements having different color temperatures; and a lighting control unit configured to control the light source unit. The lighting control unit is configured to perform: a first lighting process of supplying a first supply current to a first light emission element group of the plurality of the light emission elements such that the light source unit emits light having a first color temperature; and a second lighting process of supplying a second supply current to a second light emission element group of the plurality of the light emission elements such that the light source unit emits light having a second color temperature different from the first color temperature. The lighting control unit is configured to adjust magnitudes of each of the first supply current and the second supply current such that first luminous flux of the light source unit in the first lighting process is identical to second luminous flux of the light source unit in the second lighting process.

As for the lighting device of the second aspect in accordance with the present invention, in addition to the first aspect, the lighting control unit is configured to adjust the first supply current to a magnitude different from the magnitude of the second supply current such that the first luminous flux is identical to the second luminous flux.

As for the lighting device of the third aspect in accordance with the present invention, in addition to the second aspect, the first color temperature is lower than the second color temperature. The lighting control unit is configured to adjust the second supply current to a magnitude lower than the magnitude of the first supply current such that the first luminous flux is identical to the second luminous flux.

As for the lighting device of the fourth aspect in accordance with the present invention, in addition to the third aspect, the number of the light emission elements included in the first light emission element group and the number of the light emission elements included in the second light emission element group are determined such that the first luminous flux is less than the second luminous flux when the first supply current and the second supply current have the same magnitude.

As for the lighting device of the fifth aspect in accordance with the present invention, in addition to the fourth aspect, the number of the light emission elements included in the first light emission element group is identical to the number of the light emission elements included in the second light emission element group.

As for the lighting device of the sixth aspect in accordance with the present invention, in addition to the first aspect, the first light emission element group and the second light emission element group are determined such that the first luminous flux is identical to the second luminous flux when the first supply current and the second supply current have the same magnitude. The lighting control unit is configured to make the first supply current and the second supply current have the same magnitude.

As for the lighting device of the seventh aspect in accordance with the present invention, in addition to the sixth aspect, the number of the light emission elements included in the first light emission element group and the number of the light emission elements included in the second light emission element group are determined such that the first luminous flux is identical to the second luminous flux when the first supply current and the second supply current have the same magnitude.

As for the lighting device of the eighth aspect in accordance with the present invention, in addition to the seventh aspect, the first color temperature is lower than the second color temperature. The number of the light emission elements included in the first light emission element group is greater than the number of the light emission elements included in the second light emission group.

As for the lighting device of the ninth aspect in accordance with the present invention, in addition to any one of the first to eighth aspects, the first color temperature is lower than the second color temperature. The first light emission group includes a first light emission element configured to emit light serving as a dominant component of the light having the first color temperature. The first supply current has a magnitude which is selected such that luminous flux of the first light emission element equals to rated luminous flux of the first light emission element.

As for the lighting device of the tenth aspect in accordance with the present invention, in addition to any one of the first to eighth aspects, the first color temperature is lower than the second color temperature. The second light emission group includes a second light emission element configured to emit light serving as a dominant component of the light having the second color temperature. The second supply current has a magnitude which is selected such that luminous flux of the second light emission element equals to rated luminous flux of the second light emission element.

As for the lighting device of the eleventh aspect in accordance with the present invention, in addition to any one of the first to tenth aspects, the lighting device includes an illuminance detection unit configured to measure an illuminance at a predetermined area. The lighting control unit is configured to adjust the magnitude of each of the first supply current and the second supply current such that the illuminance measured by the illuminance detection unit is identical to a predetermined value.

The lighting fixture of the twelfth aspect in accordance with the present invention includes: the lighting device defined by any one of the first to eleventh aspects; and a fixture body configured to hold the lighting device.

### BRIEF DESCRIPTION OF THE DRAWINGS

FIG. 1 is a schematic view illustrating the lighting device of the first embodiment,

FIG. 2 is a schematic view illustrating the light source unit of the lighting device of the first embodiment,

FIG. 3 is a block diagram illustrating the lighting device of the first embodiment,

FIG. 4 is a block diagram illustrating the lighting circuit unit of the lighting device of the first embodiment,

FIG. 5 is a schematic front view illustrating the light source unit of the lighting device of the first embodiment,

FIG. 6 is a graph illustrating a relation between a forward current and relative luminous flux of an LED used in the light source unit of the lighting device of the first embodiment,

FIG. 7 is an explanatory view illustrating a relation between total luminous flux and a color-adjusting ratio of the light source unit of the lighting device of the first embodiment,

FIG. 8 is a block diagram illustrating a remote controller used for control of the lighting device of the first embodiment,

FIG. 9 is a schematic front view illustrating the remote controller,

FIG. 10 is a schematic view illustrating the light source unit of the lighting device of the third embodiment,

FIG. 11 is a graph illustrating a relation between a forward current and relative luminous flux of an LED used in the light source unit of the lighting device of the third embodiment,

FIG. 12 is an explanatory view illustrating a relation between the total luminous flux and the color-adjusting ratio of the light source unit of the lighting device of the third embodiment,

FIG. 13 is a schematic view illustrating the light source unit of the lighting device of the fourth embodiment,

FIG. 14 is an explanatory view illustrating a relation between the total luminous flux and the color-adjusting ratio of the light source unit of the lighting device of the fourth embodiment,

FIG. 15 is a schematic view illustrating the lighting device of the fifth embodiment,

FIG. 16 is a schematic view illustrating the light source unit of the lighting device of the fifth embodiment,

FIG. 17 is a schematic front view illustrating the light source unit of the lighting device of the fifth embodiment,

FIG. 18 is an explanatory view illustrating a relation between the total luminous flux and the color-adjusting ratio of the light source unit of the lighting device of the fifth embodiment,

FIG. 19 is a sectional view illustrating the lighting fixture of the sixth embodiment fixed to a ceiling, and

FIG. 20 is an exploded perspective view illustrating the lighting fixture of the sixth embodiment.

### DESCRIPTION OF EMBODIMENTS

### First Embodiment

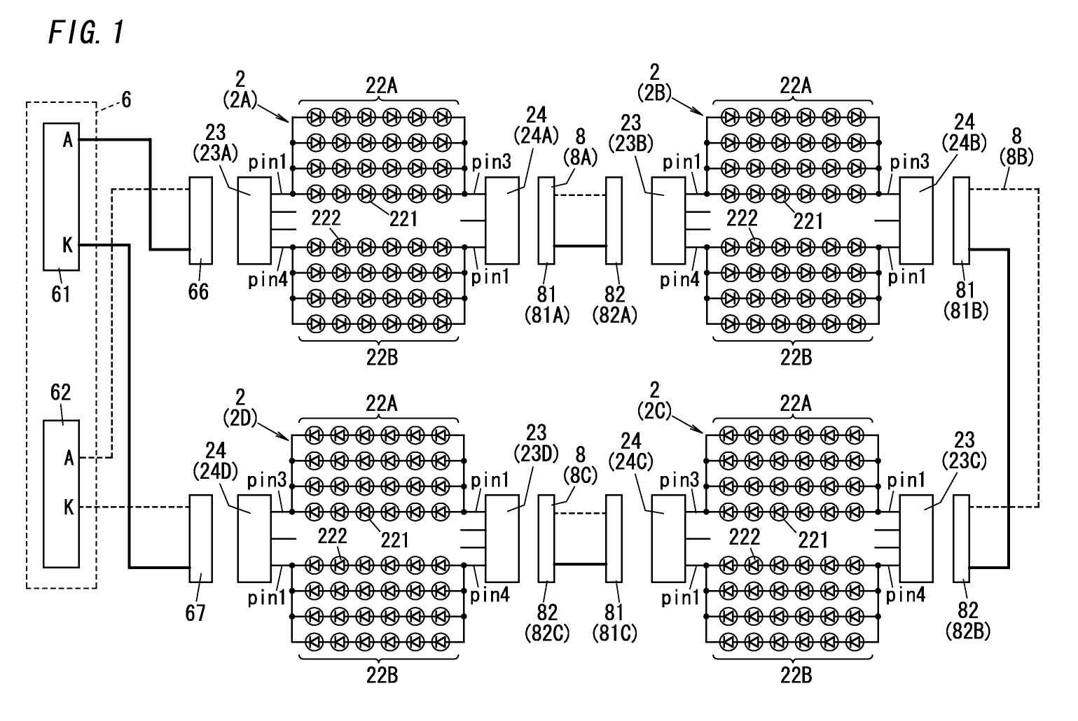

As shown in FIG. 1, the lighting device of the present embodiment includes a plurality of (four, in the illustrated instance) light source units 2 and a lighting control unit 6 configured to control the light source units 2. Note that, the number of the light source units 2 is not limited to four. In other words, the lighting device may include one or more light source units 2.

The light source unit 2 includes a plurality of (48, in the illustrated instance) light emission elements 220 having different color temperatures. In the present embodiment, the light emission element 220 is an LED. Therefore, the light source unit 2 is considered as an LED unit.

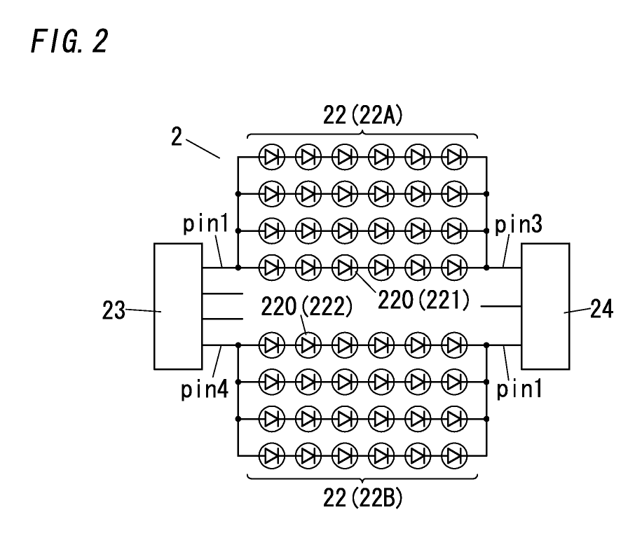

The plural light emission elements (LEDs) 220 include two kinds of light emission elements (LEDs) 221 and 222 having mutually different color temperatures. For example, as shown in FIG. 2, the light source unit 2 includes the twenty-four (first) light emission elements (LEDs) 221 and the twenty-four (second) light emission elements (LEDs) 222.

The first light emission element (LED) 221 is configured to emit light having a relatively low color temperature (e.g., light with a color corresponding to a lamp color). The twenty-four first light emission elements 221 out of the forty-eight light emission elements 220 constitute a light emission element group (first light emission element group) for enabling the light source unit 2 to emit light having a predetermined color temperature (first color temperature). In other words, the first light emission element group includes the first light emission elements (LED) 221 configured to emit light serving as a dominant component of the light having the first color temperature (the color temperature corresponding to the lamp color). Hence, the first light emission element group defines a light source (LED light source) 22 (22A) configured to emit light with the first color temperature.

The second light emission element (LED) 222 is configured to emit light having a relatively high color temperature (e.g., light with a color corresponding to a natural white color). The twenty-four second light emission elements 222 out of the forty-eight light emission elements 220 constitute a light emission element group (second light emission element group) for enabling the light source unit 2 to emit light having a predetermined color temperature (second color temperature different from the first color temperature). In other words, the second light emission element group includes the second light emission elements (LED) 222 configured to emit light serving as a dominant component of the light having the second color temperature (the color temperature corresponding to the natural white color). Hence, the second light emission element group defines a light source (LED light source) 22 (22B) configured to emit light with the second color temperature.

Note that, the light emission element group may be constituted by one light emission element 220. In other words, the light emission element group may be constituted by one or more light emission elements 220.

The light source unit 2 of the present embodiment includes the two light emission element groups (i.e., the LED unit 2 includes the two LED light sources 22). However, the light source unit 2 may include the three or more light emission element groups (i.e., the LED unit 2 may include the three or more LED light sources 22).

The lighting control unit 6 is configured to perform a plurality of lighting processes. In the lighting process, the lighting control unit 6 supplies a predetermined supply current to a predetermined light emission element group out of the plurality of the light emission elements 220, thereby enabling the light source unit 2 to emit light having a predetermined color temperature.

For example, the lighting control unit 6 is configured to perform the two lighting processes (a first lighting process and a second lighting process).

In the first lighting process, the lighting control unit 6 supplies a first supply current to the first light emission element group (LED light source) 22A of the plurality of the light emission elements 220 such that the light source unit 2 emits light having the first color temperature (in the present embodiment, light having the lamp color).

In the second lighting process, the lighting control unit 6 supplies a second supply current to the second light emission element group (LED light source) 22B of the plurality of the light emission elements 220 such that the light source unit 2 emits light having the second color temperature (in the present embodiment, light having the natural white color) different from the first color temperature.

Further, the lighting control unit 6 is configured to adjust magnitudes of the supply currents in the respective lighting processes such that the light source unit 2 has the same luminous flux (total luminous flux) with regard to the respective lighting processes.

For example, the lighting control unit 6 is configured to adjust magnitudes of each of the first supply current and the second supply current such that luminous flux (first luminous flux) of the light source unit 2 in the first lighting process is identical to luminous flux (second luminous flux) of the light source unit 2 in the second lighting process. Note that, the first luminous flux need not be identical to the second luminous flux in a strict sense. As long as switch between the first lighting process and the second lighting process gives no feeling of strangeness to a user, the first luminous flux may be considered to be identical to the second luminous flux.

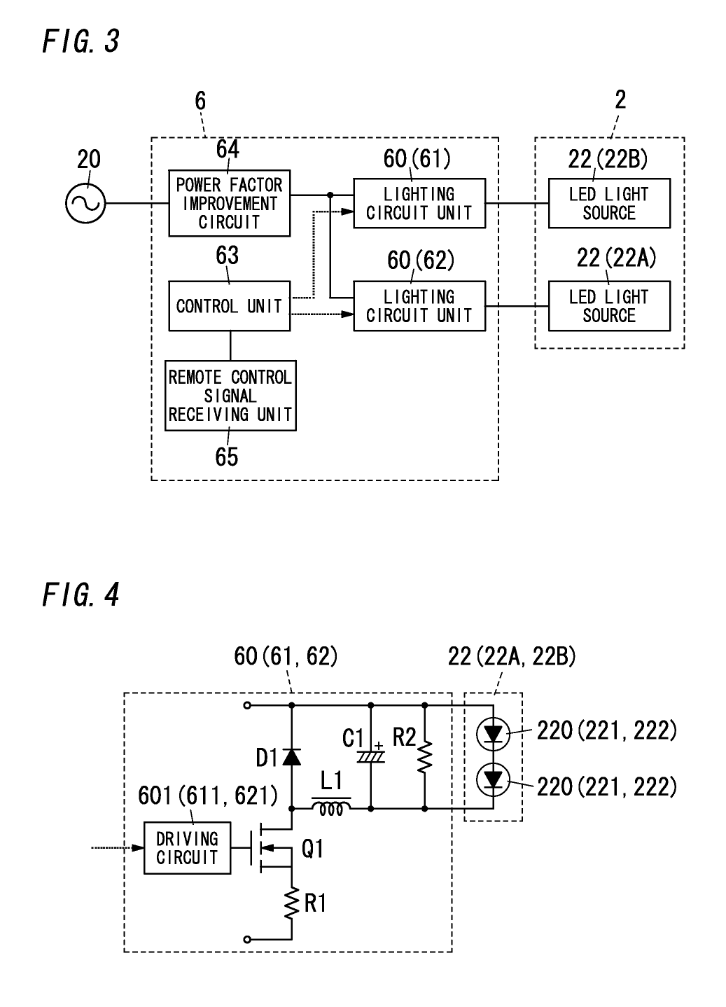

The following is a detailed explanation of the lighting device of the present embodiment. As shown in FIG. 3, the lighting device of the present embodiment includes the LED unit 2, and the lighting control unit 6 configured to perform lighting control of each of the LED light sources 22 (22A and 22B) of the LED unit 2.

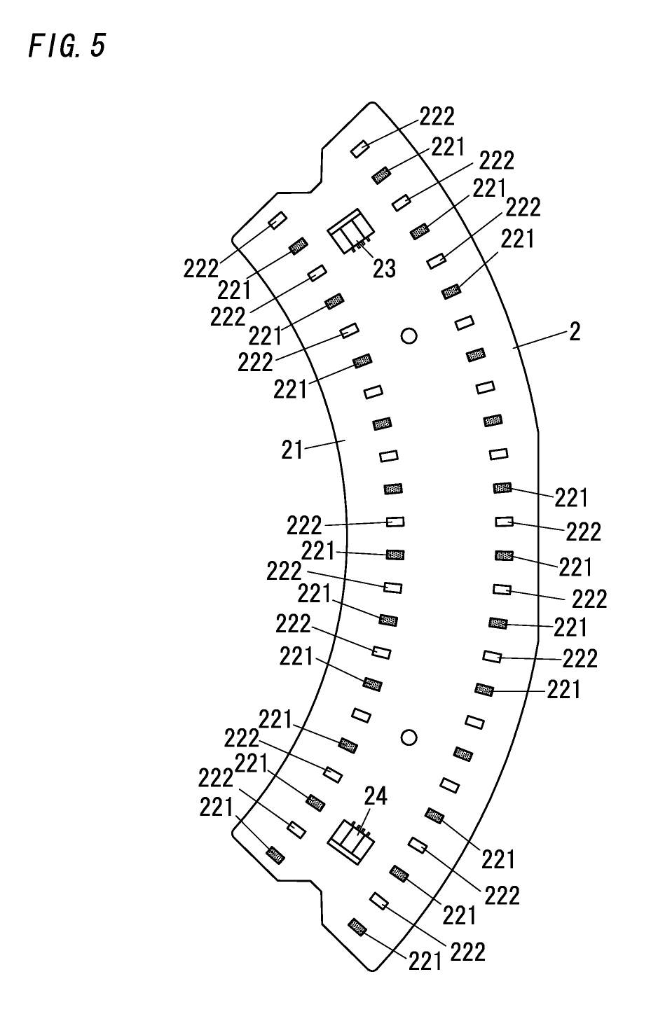

FIG. 5 is an external view (schematic front view) illustrating the LED unit 2. This LED unit 2 includes a printed board 21 formed into a circular arc shape, a plurality of (forty-eight, in the present embodiment) the LEDs 220 (221 and 222) mounted on the printed board 21, and connectors 23 and 24 designed to electrically connect the adjacent printed boards 21 and 21.

The printed board 21 is made by use of resin or metal (e.g., aluminum), for example. The printed board 21 is formed into a circular arc shape (substantially fan-like shape). For example, the printed board 21 has a thickness of 1.0 mm. Note that, the shape of the printed board 21 is not limited to a circular arc shape.

The LEDs 221 and 222 having mutual different color temperatures are mounted alternately on a surface of the printed board 21 in two lines across a lateral direction (width direction) of the printed board 21 and along a lengthwise direction of the printed board 21.

Concretely, the thirteen LEDs 221 and the thirteen LED 222 are arranged in the outer line (right side line, in FIG. 5), and the eleven LEDs 221 and the eleven LED 222 are arranged in the inner line (left side line, in FIG. 5).

In other words, mounted on the surface of the printed board 21 are the LEDs 221 and 222 with mutually different color temperature. Provided to a first side (right side, in FIG. 5) in the lateral direction (width direction) of the surface of the printed board 21 is a light emission element array (first light emission light array) extending along the lengthwise direction of the printed board 21, and provided to a second side (left side, in FIG. 5) in the lateral direction (width direction) of the surface of the printed board 21 is a light emission element array (second light emission light array) extending along the lengthwise direction of the printed board 21.

The first light emission array includes a total of the twenty-six LEDs 220 (the thirteen LEDs 221 and the thirteen LEDs 222). The second light emission array includes a total of the twenty-two LEDs 220 (the eleven LEDs 221 and the eleven LEDs 222).

In the first and second light emission arrays, the LEDs 221 and 222 are arranged alternately in line at regular intervals. Besides, in FIG. 5, in order to distinguish between the LEDs 221 and 222, the LEDs 221 is shown with a dot pattern.

In other words, a plurality of the LEDs 221 and a plurality of the LEDs 222 are mounted on the surface of the printed board 21 such that luminous flux is distributed with uniformity in the surface of the printed board 21 (i.e., a surface of the LED unit 2). Therefore, luminance at the surface of the LED unit 2 is uniform regardless of the first lighting process or the second lighting process.

With arranging the LEDs 221 and 222 alternately in such a manner, the LEDs 221 and 222 are arranged evenly. Thus, light unevenness can be suppressed.

Further, a light emission region of the LED unit 2 in the first lighting process is substantially identical to a light emission region of the LED unit 2 in the second lighting process. Therefore, switch between the first lighting process and the second lighting process would not cause a substantial change in the light emission region of the LED unit 2. Hence, it is possible to prevent a user from feeling strange.

The connectors 23 and 24 are mounted on opposite ends in the lengthwise direction of the printed board 21, respectively. With respectively mounting the connectors 23 and 24 at the opposite ends, it is possible to shorten a harness 8 (see FIG. 1) for connecting the adjacent LED units 2 and 2.

In the present embodiment, a plurality of the LEDs 221 constitute the light source (LED light source) 22A, and a plurality of the LEDs 222 constitute the light source (LED light source) 22B.

The connector 23 is used for connecting an anode terminal of the LED light source 22 to an external circuitry (e.g., the lighting control unit 6 and another LED unit 2). The connector 24 is used for connecting a cathode terminal of the LED light source 22 to an external circuitry (e.g., the lighting control unit 6 and another LED unit 2).

FIG. 2 is a circuit diagram illustrating the LED unit (light source) 2.

The LED light source 22A includes four series circuits connected in parallel, and each series circuit is formed by connecting the six LEDs 221 (e.g., “NS2L157ART-H3” available from Nichia chemical industries) designed to emit light having a relatively low color temperature (e.g., light having a color corresponding to a lamp color). Further, each series circuit has an anode side connected to a first pin pin1 of the connector 23 and has a cathode side connected to a third pin pin3 of the connector 24.

The LED light source 22B includes four series circuits connected in parallel, and each series circuit is formed by connecting the six LEDs 222 (e.g., “NS2W157ART-H3” available from Nichia chemical industries) designed to emit light having a relatively high color temperature (e.g., light having a color corresponding to a natural white color). Further, each series circuit has an anode side connected to a fourth pin pin4 of the connector 23 and has a cathode side connected to a first pin pin1 of the connector 24.

According to Japanese Industrial Standard (JIS Z9110 General rules of recommended lighting levels), a color of light having a correlated color temperature less than 3300 K is defined as “warm color”, and a color of light having a correlated color temperature greater than 5300 K is defined as “cool color”, and a color of light having a correlated color temperature in a range of 3300 K to 5300 is defined as “intermediate color”.

When currents with the same magnitude are supplied to an LED having a relatively high color temperature and an LED having a relatively low color temperature respectively, the LED with a relatively high color temperature shows luminous flux greater than that of the LED with a relatively low color temperature. In the present embodiment, when currents with the same magnitude are supplied to the LEDs 221 and 222 respectively, the LED 222 has luminous flux greater than that of the LED 221.

As mentioned above, in the light source unit (LED unit) 2 of the present embodiment, the first color temperature is lower than the second color temperature. For example, the first color temperature is a color temperature of light corresponding to a lamp color, and the second color temperature is a color temperature of light corresponding to a natural white color. Note that, the first color temperature and the second color temperature are not limited to the above instances.

In this embodiment, the number of the light emission elements (LEDs) 221 included in the first light emission element group (LED light source) 22A and the number of the light emission elements (LEDs) 222 included in the second light emission element group (LED light source) 22B are determined such that the first luminous flux is less than the second luminous flux when the first supply current and the second supply current have the same magnitude.

Particularly, in the lighting device of the present embodiment, the number of the light emission elements (LEDs) 221 included in the first light emission element group (LED light source) 22A is identical to the number of the light emission elements (LEDs) 222 included in the second light emission element group (LED light source) 22B. For example, each of the number of the (LEDs 221 included in the LED light source 22A and the number of the (LEDs 222 included in the LED light source 22B is 24.

Further, in the lighting device of the present embodiment, a plurality of the LEDs 220 (221 and 222) and the substrate (printed board) 21 on which the plurality of the LEDs 220 is mounted. The plural LEDs 221 and the plural LEDs 222 are mounted on the surface of the printed board 21 such that the luminous flux is distributed uniformly in the surface of the printed board 21 (i.e., the surface of the LED unit 2). Hence, the luminance is made uniform in the surface of the LED unit 2 irrespective of either the first lighting process or the second lighting process.

Furthermore, the plural LEDs 221 and the plural LEDs 222 are arranged alternately on the surface of the printed board 21. Thus, the light emission region of the LED unit 2 in the first lighting process is substantially identical to the light emission region of the LED unit 2 in the second lighting process. Therefore, switch between the first lighting process and the second lighting process would not cause a substantial change in the light emission region of the LED unit 2. Hence, a user can be prevented from feeling strange.

For example, as shown in FIG. 3, the lighting control unit 6 includes a plurality of (two, in the illustrated instance) lighting circuit units 60 (61 and 62), a control unit 63 configured to individually control the lighting circuit units 60 (61 and 62), a power factor improvement circuit 64, and a remote control signal receiving unit 65.

The power factor improvement circuit 64 is a well-known boost chopper circuit. The power factor improvement circuit 64 outputs a DC voltage higher than an AC voltage supplied from a commercial AC power source 20.

The control unit 63 is constituted by a microcomputer and a memory (e.g., a ROM and a RAM). The control unit 63 respectively controls the lighting circuit units 61 and 62 in conformity with programs preliminarily stored in the memory. Besides, a power supply circuit (not shown) generates power for operating the control unit 63 from the output voltage of the power factor improvement circuit 64 and supplies it to the control unit 63.

The lighting circuit unit 60 (61, 62) is, as shown in FIG. 4, constituted by a boost chopper circuit configured to decrease the DC voltage outputted from the power factor improvement circuit 64 down to a desired DC voltage, and a driving circuit 601 (611, 621) configured to drive the boost chopper circuit.

The boot chopper circuit includes a diode D1, a switching element Q1, a resistor R1, a smoothing capacitor C1, an inductor L1, and a resistor R2.

Such a boost chopper circuit is well known. The power factor improvement circuit 64 has a positive output terminal connected to a cathode of the diode D1. Interposed between an anode of the diode D1 and a negative output terminal of the power factor improvement circuit 64 is a series circuit of the switching element Q1 and the resistor R1. Additionally, interposed between the cathode and the anode of the diode D1 is a series circuit of the smoothing capacitor C1 and the inductor L1. The smoothing capacitor C1 is an electrolytic capacitor. The resistor R2 used for discharging is connected between opposite ends of the smoothing capacitor C1.

The operation of this boost chopper circuit is well known. With turning on and off the switching element Q1 at a high frequency, the DC voltage obtained by decreasing the input voltage (output voltage of the power factor improvement circuit 64) is outputted via the opposite ends of the smoothing capacitor C1.

The driving circuit 601 (611, 621) is configured to turn on and off the switching element Q1 in accordance with a control signal provided from the control unit 63.

The control unit 63 operates the switching element Q1 of the lighting circuit unit 60 (61, 62) intermittently. The control unit 63 selects a duty rate of operation period (on-period) to a period of the intermittent operation from a range of a lower limit (e.g., 5%) to an upper limit (e.g., 100%), thereby adjusting (dimming) the light output of the LED light source 22 (22A, 22B).

In other words, the light output (luminous flux) of the LED light source 22 (22A, 22B) is increased with an increase in the duty rate, and the light output (luminous flux) of the LED light source 22 (22A, 22B) is decreased with a decrease in the duty rate. When the duty rate is 100% (the upper limit of a dimming range), the switching element Q1 is kept turned on, and the LED light source 22 (22A, 22B) is lit at a rated light output. In contrast, when the duty rate is zero, the on-period is also zero. Thus, the switching element Q1 is kept turned off. Hence, the LED light source 22 (22A, 22B) is turned off. Note that, in the following explanation, the aforementioned duty rate is referred to as a dimming rate, if necessary.

In the present embodiment, the luminescent color (lamp color) of the LED 221 of the LED light source 22A and the luminescent color (natural white color) of the LED 222 of the LED light source 22B are different from each other. Consequently, the control unit 63 can select the color of light emitted to the lighting space from the LED light sources 22A and 22B (hereinafter, referred to as “illumination light”) from the lamp color, the intermediate color (a color between the lamp color and the natural white color), and the natural white color (i.e., the control unit 63 can perform color selection), by means of changing proportions of the light output (dimming rate) of the LED light source 22A and the light output (dimming rate) of the LED light source 22B.

In brief, the color temperature is decreased with an increase in the proportion of the light output (dimming rate) of the LED light source 22A, and the color temperature is increased with an increase in the proportion of the light output (dimming rate) of the LED light source 22B.

When the dimming rate of the LED light source 22A is greater than 0% and the dimming rate of the LED light source 22B is equal to 0%, the color of light is the lamp color. When the dimming rate of the LED light source 22A is equal to 0% and the dimming rate of the LED light source 22B is greater than 0%, the color of light is the natural white color.

In brief, when the LED light source 22A is turned on and the LED light source 22B is turned off, the LED unit 2 emits light with the lamp color. When the LED light source 22A is turned off and the LED light source 22B is turned on, the LED unit 2 emits light with the natural white color.

Note that, in the following explanation, a ratio of the dimming rate of the LED light source 22A to the dimming rate of the LED light source 22B is referred to as a color-adjusting ratio, and a total of the dimming rate of the LED light source 22A and the dimming rate of the LED light source 22B (i.e., the dimming rate of the illumination light) is referred to as a total color-adjusting ratio.

FIG. 7 is a diagram schematically illustrating a relation between the total luminous flux of the LED light sources 22A and 22B and the color-adjusting ratio.

P1 in FIG. 7 represents a state in which the dimming rate of the LED light source 22A is 0% and the dimming rate of the LED light source 22B is 100% (i.e., the color-adjusting ratio=0:100). The state represented by P1 is corresponding to a state in which the lighting control unit 6 performs the second lighting process. In brief, in P1, the LED unit 2 emits light with the natural white color. Note that, in P1, the dimming rate of the LED light source 22A may be not 0% but 5% (the lower limit). With regard to P1, since the dimming rate of the LED light source 22B is 100%, light emitted from the LED unit 2 is unsusceptible to light emitted from the LED light source 22A, and is substantially equal to light with the natural white color.

P2 in FIG. 7 represents a state in which the dimming rate of the LED light source 22A is 100% and the dimming rate of the LED light source 22B is 0% (i.e., the color-adjusting ratio=100:0). The state represented by P2 is corresponding to a state in which the lighting control unit 6 performs the first lighting process. In brief, in P2, the LED unit 2 emits light with the lamp color. Note that, in P2, the dimming rate of the LED light source 22B may be not 0% but 5% (the lower limit). With regard to P2, since the dimming rate of the LED light source 22A is 100%, light emitted from the LED unit 2 is unsusceptible to light emitted from the LED light source 22B, and is substantially equal to light with the lamp color.

P3 in FIG. 7 represents a state in which the dimming rate of the LED light source 22A is 100% and the dimming rate of the LED light source 22B is 100% (i.e., the color-adjusting ratio=100:100). In brief, when only the dimming rate of the LED light source 22A is increased from that in the state represented by P1, the color-adjusting ratio is changed from P1 to P3. Alternatively, when only the dimming rate of the LED light source 22B is decreased from that in the state represented by P3, the color-adjusting ratio is changed from P3 to P2.

In P3, since each of the dimming rates of the LED light sources 22A and 22B is 100%, light emitted from the LED unit 2 is light with the intermediate color. Further, the total luminous flux of the LED unit 2 has a maximum level at P3 (see point “d” in FIG. 7).

In brief, a position (indicated by the point “d” in FIG. 7) at which two sides having the same length of an isosceles triangle intersect is corresponding to a dimming and color-adjusting state in which the dimming rates of the respective LED light sources 22A and 22B are set to 100% (the upper limit of the dimming range). Hereinafter, this state is referred to as a “maximum lighting state”. Note that, the color of light in the maximum lighting state is the intermediate color (color between the natural white color and the lamp color).

Besides, a position (indicated by the point “b” in FIG. 7) of a left vertex of the other two vertexes of the aforementioned isosceles triangle is corresponding to a dimming and color-adjusting state in which the dimming rate of the LED light source 22B is 100% and the dimming rate of the LED light source 22A is the lower limit of the dimming range (or the LED light source 22A is turned off). Hereinafter, this state is referred to as a “first state (state in which only the LED light source 22B which emits light with a color corresponding to the natural white color is turned on)”.

In contrast, a position (indicated by the point “c” in FIG. 7) of a right vertex of the other two vertexes of the aforementioned isosceles triangle is corresponding to a dimming and color-adjusting state in which the dimming rate of the LED light source 22A is 100% and the dimming rate of the LED light source 22B is the lower limit of the dimming range (or the LED light source 22B is turned off). Hereinafter, this state is referred to as a “second state (state in which only the LED light source 22A which emits light with a color corresponding to the lamp color is turned on)”.

A state included in the isosceles triangle in FIG. 7 is corresponding to a dimming and color-adjusting state in which the dimming rates of the LED light sources 22A and 22B are set to arbitrary levels so long as the total dimming ratio is kept not less than 100%. Further, a state included in the rectangle in FIG. 7 is corresponding to a dimming and color-adjusting state in which the dimming rates of the LED light sources 22A and 22B are set to arbitrary levels so long as the total dimming ratio is kept less than 100%. An arbitrary position in an inside (including edges) of the figure (pentagon) defined as a combination of the isosceles triangle and the rectangle is corresponding to a dimming and color-adjusting state of the illumination light.

The remote control signal receiving unit 65 receives an infrared signal (receive light) sent from a remote controller 9. The remote control signal receiving unit 65 demodulates the received infrared signal to obtain a control code and then outputs it to the control unit 63.

The control unit 63 individually controls the lighting circuit units 61 and 62 to adjust the dimming rates of the respective LED light sources 22A and 22B such that the total dimming rate and the color-adjusting ratio are corresponding to those of the control code. Besides, instead of the infrared signal, a wireless signal using an electric wave as a medium or an electric signal passing through a signal line may be sent from the remote controller 9.

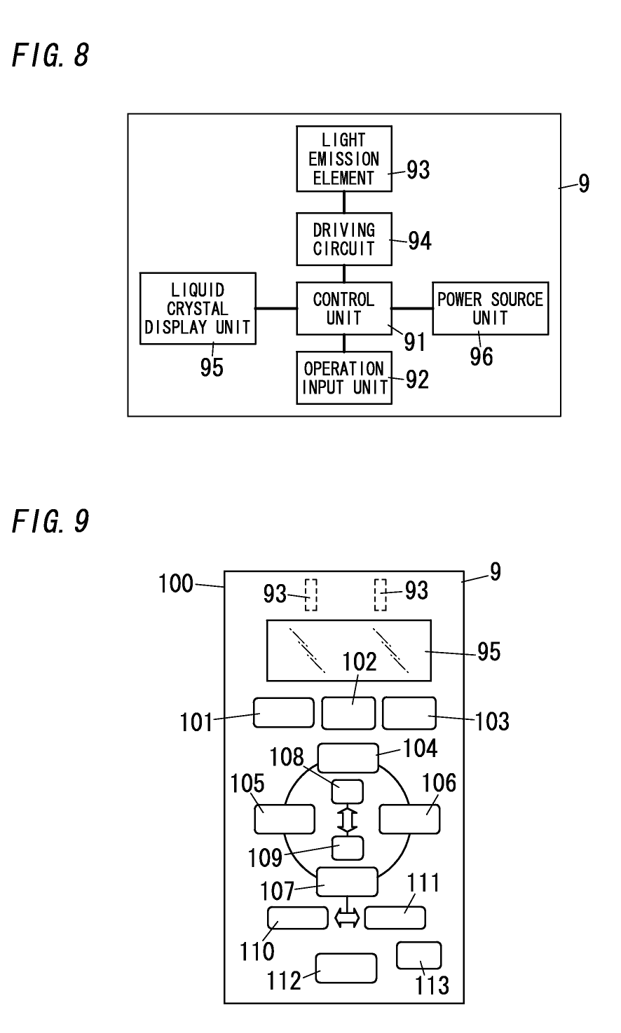

As shown in FIG. 8, the remote controller 9 includes a control unit 91, an operation input unit 92, a light emission element 93, a driving circuit 94, a liquid crystal display unit 95, and a power source unit 96.

The light emission element 93 is a light source for sending an infrared signal. For example, the light emission element 93 is an infrared light emitting diode. Upon receiving a driving current from the driving circuit 94, the light emission element 93 emits (transmits) an infrared ray (infrared signal).

The operation input unit 92 includes a plurality of push switches (not shown) which are individually turned on when plural kinds of push buttons mentioned below are pushed. When the push switch is turned on, the operation input unit 92 receives an operation input corresponding to the pushed push switch and outputs an operation signal to the control unit 91.

The control unit 91 generates the control code corresponding to the operation signal received from the operation input unit 92 and outputs it to the driving circuit 94, or controls the liquid crystal display unit 95 in such a manner to display characters corresponding to the operation signal or the control code, for example.

Note that, the control code is modulated by the driving circuit 94 and is sent from the light emission element 93 as the infrared signal.

The power source unit 96 supplies driving power to the respective battery-powered units 91 to 95.

FIG. 9 is an external view (front view) illustrating the remote controller 9. The remote controller 9 has a case 100 which is a synthetic resin molded article and is formed into a flat rectangular box shape. The case 100 accommodates therein the units 91 to 96. The liquid crystal display unit 95 has a display screen exposed on an upper side of a front face of the case 100. The plural (thirteen, in the present embodiment) push buttons 101 to 113 for pushing the plural push switches of the operation input unit 92 are arranged on a lower side of this display screen.

For example, the two push buttons 108 and 109 are placed on the center of the front face of the case 100. When the upper push button 108 is pressed, the control code (dimming order [dimming rate increasing order]) for increasing the total dimming rate is generated. In contrast, when the lower push button 109 is pressed, the control code (dimming order [dimming rate decreasing order]) for decreasing the total dimming rate is generated. When the pressing operation of the push button 108 or 109 is terminated, the control code (dimming order [dimming termination order]) for terminating increasing or decreasing the total dimming rate is generated. Once receiving the dimming rate increasing order or the dimming rate decreasing order, until receiving the dimming termination order, the control unit 63 adjusts the dimming rates of the respective LED light sources 22A and 22B by controlling the lighting circuit units 61 and 62 such that only the total dimming rate is continuously increased or decreased with keeping the color-adjusting ratio constant.

Further, the two push buttons 110 and 111 are placed on the lower part of the front face of the case 100. When the left push button 110 is pressed, the control code (color-adjusting order [color-adjusting level decreasing order]) for decreasing the color-adjusting ratio (for increasing the color temperature) is generated. In contrast, when the right push button 111 is pressed, the control code (color-adjusting order [color-adjusting level increasing order]) for increasing the color-adjusting ratio (for decreasing the color temperature) is generated. When the pressing operation of the push button 110 or 111 is terminated, the control code (color-adjusting order [color-adjusting termination order]) for terminating increasing or decreasing the color-adjusting ratio is generated. Once receiving the color-adjusting level increasing order or the color-adjusting level decreasing order, until receiving the color-adjusting termination order, the control unit 63 adjusts the dimming rates of the respective LED light sources 22A and 22B by controlling the lighting circuit units 61 and 62 such that only the color-adjusting ratio is continuously increased or decreased with keeping the total dimming rate constant.

Furthermore, the four push buttons 104 to 107 are arranged in a circle to surround the two push buttons 108 and 109. When the upper push button 104 is pushed, the control code for changing the dimming and color-adjusting state to the “maximum lighting state” is generated. When the left push button 105 is pushed, the control code for changing the dimming and color-adjusting state to the “first state” is generated. When the right push button 106 is pushed, the control code for changing the dimming and color-adjusting state to the “second state” is generated. When the lower push button 107 is pushed, the control code for changing the dimming and color-adjusting state to the dimming and color-adjusting state preliminarily stored in the memory of the control unit 63 by a user is generated. In other words, in the present embodiment, when the left push button 105 is pushed, the maximum lighting order for turning on the LED light source 22B at the maximum light output is outputted. When the right push button 106 is pushed, the maximum lighting order for turning on the LED light source 22A at the maximum light output is outputted.

Moreover, the three push buttons 101 to 103 are arranged in a lateral direction on the front face of the case 100 to be located immediately below the liquid crystal display unit 95. When the center push button 102 is pushed, the control code for storing the dimming and color-adjusting state (the total dimming rate and the color-adjusting ratio) in the memory of the control unit 63 is generated. Upon receiving this control code, the control unit 63 stores the total dimming rate and the color-adjusting ratio at this time in the memory. Upon receiving the control code generated in response to pushing the push button 107, the control unit 63 changes the dimming and color-adjusting state to the dimming and color-adjusting state stored in the memory. When the left push button 101 is pushed, the control code for automatic dimming control or automatic turning-off control based on outside light is generated. Note that, when the push button 112 located on the lowest part of the front face of the case 100 is pushed, the control code for turning off all the LED light sources 22A and 22B is generated.

FIG. 1 shows an instance illustrating connection between the lighting control unit 6 and the LED unit 2. In the present embodiment, the four LED units 2 are connected to the lighting control unit 6. In the following explanation, in order to distinguish between the four LED units 2, the four LED units 2 may be represented as the LED units 2A to 2D.

The lighting circuit unit 60 (61, 62) includes a positive side (high voltage side) output terminal (represented by “A” in FIG. 1) and a negative side (low voltage side) output terminal (represented by “K” in FIG. 1).

The positive side output terminals of the respective lighting circuit units 61 and 62 are connected to a connector 66. The negative side output terminals of the respective lighting circuit units 61 and 62 are connected to a connector 67.

The connector 66 is connected to the connector 23 (23A) on the anode side of the LED unit 2 (2A). Hence, the positive side output terminals of the lighting circuit units 61 and 62 are connected to the fourth pin pin4 and the first pin pin1 of the connector 23A via the connector 66, respectively.

The connector 67 is connected to the connector 24 (24D) on the cathode side of the LED unit 2 (2D). Hence, the negative side output terminals of the lighting circuit units 61 and 62 are connected to the first pin pin1 and the third pin pin3 of the connector 24D via the connector 67, respectively.

The LED unit 2A is connected to the LED unit 2B via the harness 8 (8A). In detail, the connector 24 (24A) on the cathode side of the LED unit 2A is connected to a first connector 81A of the harness 8A, and the connector 23 (23B) on the anode side of the LED unit 2B is connected to a second connector 82A of the harness 8A. Thus, the first pin pin1 and the third pin3 of the connector 24A of the LED unit 2A are electrically connected to the fourth pin pin4 and the first pin1 of the connector 23B of the LED unit 2B via the harness 8A, respectively.

The LED unit 2B is connected to the LED unit 2C via the harness 8 (8B). In detail, the connector 24 (24B) on the cathode side of the LED unit 2B is connected to the first connector 81B of the harness 8B, and the connector 23 (23C) on the anode side of the LED unit 2C is connected to the second connector 82B of the harness 8B. Thus, the first pin pin1 and the third pin3 of the connector 24B of the LED unit 2B are electrically connected to the fourth pin pin4 and the first pin1 of the connector 23C of the LED unit 2C via the harness 8B, respectively.

The LED unit 2C is connected to the LED unit 2D via the harness 8 (8C). In detail, the connector 24 (24C) on the cathode side of the LED unit 2C is connected to the first connector 81C of the harness 8C, and the connector 23 (23D) on the anode side of the LED unit 2D is connected to the second connector 82C of the harness 8C. Thus, the first pin pin1 and the third pin3 of the connector 24C of the LED unit 2C are electrically connected to the fourth pin pin4 and the first pin1 of the connector 23D of the LED unit 2D via the harness 8C, respectively.

In this manner, the LED light source 22B of the LED unit 2A, the LED light source 22B of the LED unit 2B, the LED light source 22B of the LED unit 2C, and the LED light source 22B of the LED unit 2D are connected in series with each other between the output terminals of the lighting circuit unit 61. In the present embodiment, the ninety-six LEDs 222 are connected between the output terminals of the lighting circuit unit 61.

Further, the LED light source 22A of the LED unit 2A, the LED light source 22A of the LED unit 2B, the LED light source 22A of the LED unit 2C, and the LED light source 22A of the LED unit 2D are connected in series with each other between the output terminals of the lighting circuit unit 62. In the present embodiment, the ninety-six LEDs 221 are connected between the output terminals of the lighting circuit unit 62.

As mentioned above, in the lighting device of the present embodiment, the connector 66 which has the fourth pin pin4 connected to the positive side output terminal of the lighting circuit unit 61 of the lighting control unit 6 and the first pin pin1 connected to the positive side output terminal of the lighting circuit unit 62 is connected to the connector 23 of the LED unit 2A. Additionally, the connector 67 which has the first pin pin1 connected to the negative side output terminal of the lighting circuit unit 61 of the lighting control unit 6 and the third pin pin3 connected to the negative side output terminal of the lighting circuit unit 62 is connected to the connector 24 of the LED unit 2D.

Connected between the connector 24 (24A) of the LED unit 2A and the connectors 23 (23B) of the LED unit 2B, between the connector 24 (24B) of the LED unit 2B and the connectors 23 (23C) of the LED unit 2C, and between the connector 24 (24C) of the LED unit 2C and the connectors 23 (23D) of the LED unit 2D are the harnesses 8 (8A, 8B, and 8C) including the connector 81 with three pins and the connector 82 with four pins, respectively.

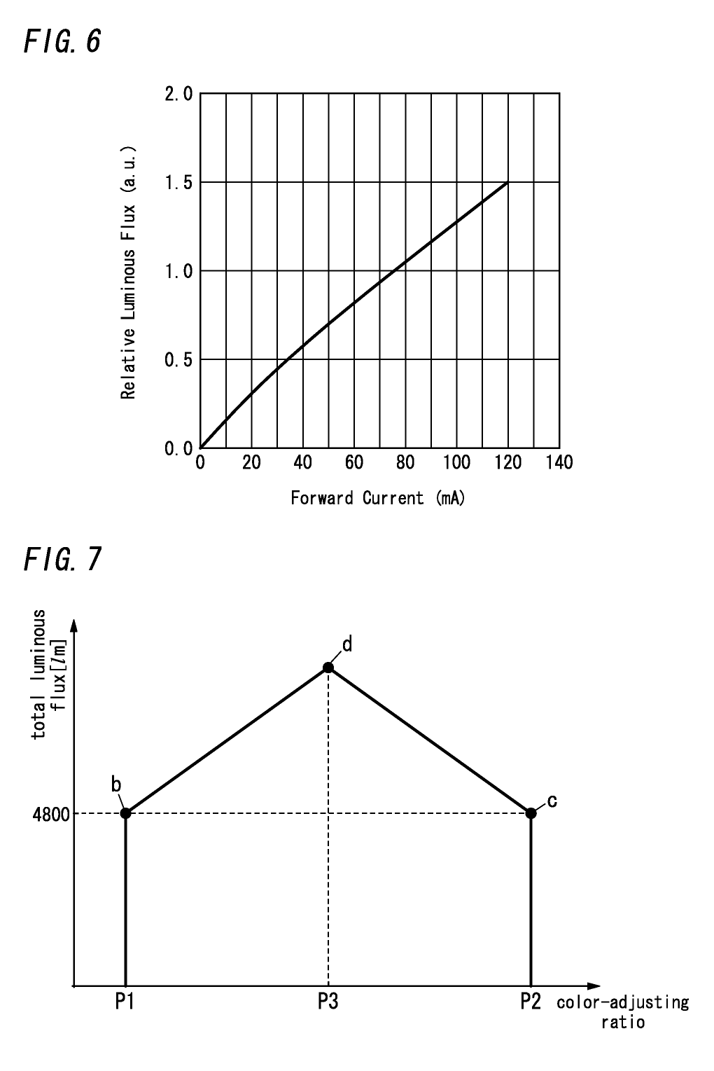

FIG. 6 shows a graph illustrating a relation between a forward current of the LED 220 (221, 222) of the LED light source 22 (22A, 22B) and relative luminous flux.

When a forward current of 75 mA flows through the LED 222 of the LED light source 22B configured to emit light with a color corresponding to the natural white color, the rated luminous flux is 50 lm. Based on FIG. 6, a relational expression between the luminous flux y2 [lm] of the LED 222 and the forward current x2 [mA] can be calculated and represented by formula (1).

$$\begin{matrix}[ FORMULA 1 ] & \\ y 2 = \frac{25}{45} \cdot x 2 + 8.3 & ( 1 )\end{matrix}$$

When the forward current of 75 mA flows through the LED 221 of the LED light source 22A configured to emit light with a color corresponding to the lamp color, the rated luminous flux is 46 lm. Similarly, a relational expression between the luminous flux y1 [lm] of the LED 221 and the forward current x1 [mA] can be calculated and represented by formula (2).

$$\begin{matrix}[ FORMULA 2 ] & \\ y 1 = \frac{23}{45} \cdot x 1 + 7.7 & ( 2 )\end{matrix}$$

In the lighting device of the present embodiment, the second supply current is equivalent to a current (rated current) that the luminous flux of the LED 222 is identical to its rated luminous flux (about 50 lm). As for the LED light source 22B, the four series circuits of the six LEDs 222 are connected in parallel with each other. Thus, to supply the forward current of 75 mA to each of the four series circuits, the second supply current is selected to be 300 mA.

Each LED unit 2 includes the LED light source 22B constituted by the twenty-four LEDs 222. Thus, the luminous flux (second luminous flux) of the LED unit 2 in the second lighting process is about 1200 lm. Consequently, a total of the luminous flux (second luminous flux) of the four LED units 2 is about 4800 lm.

The first supply current is selected such that the luminous flux (first luminous flux) of the LED unit 2 in the first lighting process is equivalent to the second luminous flux (about 1200 lm) of the LED unit 2 in the second lighting process.

The number of the LEDs 221 of the LED light source 22A is equivalent to the number of the LEDs 222 of the LED light source 22B, and is twenty-four. Hence, the first supply current is selected such that the LED 221 has the luminous flux of about 50 lm. According to aforementioned formula (2), when the forward current x1 is about 82.7 mA, the luminous flux y1 of the LED 221 is about 50 lm. As for the LED light source 22A, the four series circuits of the six LEDs 221 are connected in parallel with each other. Thus, to supply the forward current of about 82.7 mA to each of the four series circuits, the first supply current is selected to be about 330.8 mA.

Each LED unit 2 includes the LED light source 22A constituted by the twenty-four LEDs 221. Thus, the luminous flux (first luminous flux) of the LED unit 2 in the first lighting process is about 1200 lm. Consequently, a total of the luminous flux (first luminous flux) of the four LED units 2 is about 4800 lm.

In brief, the lighting control unit 6 supplies the first supply current of about 330.8 mA to a series circuit of the four LED units 2 in the first lighting process. Consequently, the luminous flux (first luminous flux) of each of the LED units 2 is about 1200 lm, and the total of the luminous flux of the four LED units 2 is about 4800 lm. In contrast, the lighting control unit 6 supplies the second supply current of about 300 mA to the series circuit of the four LED units 2 in the second lighting process. Consequently, the luminous flux (second luminous flux) of each of the LED units 2 is about 1200 lm, and the total of the luminous flux of the four LED units 2 is about 4800 lm.

As mentioned above, the lighting control unit 6 is configured to adjust the first supply current to a magnitude different from the magnitude of the second supply current such that the first luminous flux is identical to the second luminous flux. Especially, in the lighting device of the present embodiment, the first color temperature is lower than the second color temperature. In this case, the lighting control unit 6 is configured to adjust the second supply current to a magnitude lower than the magnitude of the first supply current such that the first luminous flux is identical to the second luminous flux. Further, the second supply current has a magnitude selected such that the luminous flux of the second light emission element (LED) 222 is identical to the rated luminous flux thereof.

The following explanation is made to operation of the lighting device of the present embodiment.

When the push button 105 of the remote controller 9 is pushed, the control code (the maximum lighting order to the LED light source 22B) for changing the dimming and color-adjusting state to the “first state” is inputted into the control unit 63. As a result, the control unit 63 controls the lighting circuit units 61 and 62 in such a manner to adjust the dimming rates of the respective LED light sources 22A and 22B. In brief, the lighting control unit 6 performs the second lighting process.

Concretely, the control unit 63 sets the current (second supply current) outputted from the lighting circuit unit 61 to 300 mA in order to turn on the four LED light sources 22B. As a result, the current of 75 mA (100%) flows through each of the series circuits.

Therefore, with reference to formula (1), the luminous flux of the single LED 222 of each of the LED light sources 22B is about 50 lm. Consequently, the total luminous flux of the LED units 2A to 2D each having the twenty-four LEDs 222 is about 4800 lm (point “b” in FIG. 7) when the current flowing through each LED 222 is controlled such that the output of each LED 222 is identical to the rated luminous flux.

Meanwhile, when the push button 106 of the remote controller 9 is pushed, the control code (the maximum lighting order to the LED light source 22A) for changing the dimming and color-adjusting state to the “second state” is inputted into the control unit 63. As a result, the control unit 63 controls the lighting circuit units 61 and 62 in such a manner to adjust the dimming rates of the respective LED light sources 22A and 22B. In brief, the lighting control unit 6 performs the first lighting process.

Concretely, the control unit 63 sets the current (first supply current) outputted from the lighting circuit unit 62 to 330.8 mA in order to turn on the four LED light sources 22A. As a result, the current of 82.7 mA (110.3%) flows through each of the series circuits.

Therefore, with reference to formula (2), the luminous flux of the single LED 221 of each of the LED light sources 22A is about 50 lm. Consequently, the total luminous flux of the LED units 2A to 2D each having the twenty-four LEDs 221 is about 4800 lm (point “c” in FIG. 7) when the current flowing through each LED 221 is controlled such that the output of each LED 221 is greater than the rated luminous flux (110.3%).

As mentioned in the above, the lighting device of the present embodiment includes plural kinds of the LED light sources 22 (22A and 22B) configured to emit light with different color temperatures, and the lighting control unit 6 configured to individually perform lighting control of the plural kinds of the LED light sources 22 (22A and 22B) to adjust the luminescent color. When currents with the same magnitude flow through the plural kinds of the LED light sources 22A and 22B, the luminous flux of the LED light source 22B with the relatively high color temperature is likely to be greater than the luminous flux of the LED light source 22A with the relatively low color temperature. In a state in which in response to the maximum lighting order the lighting control unit 6 turns on the corresponding LED light source 22 at the maximum light output, the lighting control unit 6 adjusts the supply current provided to the LED light source 22B with the relatively high color temperature to a magnitude lower than the supply current provided to the LED light source 22A with the relatively low color temperature such that the output luminous flux has the same magnitude.

In other words, the lighting device of the present embodiment includes: the light source unit (LED unit) 2 including a plurality of the light emission elements (LEDs) 220 (221 and 222) having different color temperatures; and the lighting control unit 6 configured to control the light source unit 2. The lighting control unit 6 is configured to perform: the first lighting process of supplying the first supply current to the first light emission element group (LED light source) 22A of the plurality of the light emission elements (LEDs) 220 such that the light source unit 2 emits light having the first color temperature; and the second lighting process of supplying the second supply current to the second light emission element group (LED light source) 22B of the plurality of the light emission elements (LEDs) 220 such that the light source unit 2 emits light having the second color temperature different from the first color temperature. The lighting control unit 6 is configured to adjust magnitudes of each of the first supply current and the second supply current such that first luminous flux of the light source unit 2 in the first lighting process is identical to second luminous flux of the light source unit 2 in the second lighting process.

Further, in the lighting device of the present embodiment, the lighting control unit 6 is configured to adjust the first supply current to a magnitude different from the magnitude of the second supply current such that the first luminous flux is identical to the second luminous flux.

Further, in the lighting device of the present embodiment, the first color temperature is lower than the second color temperature. The lighting control unit 6 is configured to adjust the second supply current to a magnitude lower than the magnitude of the first supply current such that the first luminous flux is identical to the second luminous flux.

Further, in the lighting device of the present embodiment, the number of the light emission elements (LEDs) 221 included in the first light emission element group (LED light source) 22A and the number of the light emission elements (LEDs) 222 included in the second light emission element group (LED light source) 22B are determined such that the first luminous flux is less than the second luminous flux when the first supply current and the second supply current have the same magnitude.

Further, in the lighting device of the present embodiment, the number of the light emission elements (LEDs) 221 included in the first light emission element group (LED light source) 22A is identical to the number of the light emission elements (LEDs) 222 included in the second light emission element group (LED light source) 22B.

Further, in the lighting device of the present embodiment, the first color temperature is lower than the second color temperature. The second light emission group (LED light source) 22B includes the second light emission element (LED) 222 configured to emit light serving as a dominant component of the light having the second color temperature. The second supply current has a magnitude which is selected such that the luminous flux of the second light emission element (LED) 222 equals to the rated luminous flux of the second light emission element.

Accordingly, with performing the aforementioned control, it is possible to make the total luminous flux (second luminous flux) in the first state substantially identical to the total luminous flux (first luminous flux) in the second state. Consequently, it is possible to propose the lighting device which does not give feelings of strangeness to a user when the first state is switched to the second state or the second state is switched to the first state.

Accordingly, the aforementioned lighting device of the present embodiment can reduce a change in the luminous flux due to switch of luminescent color. In other words, there is an advantage in that it is possible to propose the lighting device capable of reducing a change in the luminous flux between the plural kinds of the LED light sources 22 with different luminescent colors and the lighting fixture using the same.

As mentioned above, the lighting device of the present embodiment adjusts the output current (supply current) to the LED light source 22 such that the first luminous flux is identical to the second luminous flux. Hence, the respective LED light sources 22 can have the same number of the LEDs 220. Therefore, an interval between positions of the LEDs 220 can be made constant. Thus, it is possible to more suppress the light unevenness of the LED unit 2.

Further, in the present embodiment, to switch to the first state or the second state, a user is only required to push the push button 105 or 106. Therefore, it is possible to switch the state by performing simple operation.

Note that, in the lighting device of the present embodiment, the lighting control unit 6 may control the supply currents to the respective LED light sources such that the combining luminous flux obtained when the LED light source 22 corresponding to the maximum lighting order is turned on at the maximum luminous flux and the remaining LED light source 22 is turned off or is turned on a predetermined minimum luminous flux has the substantially same magnitude.

In the present embodiment, an illuminance detection unit (not shown) may be provided. The illuminance detection unit is configured to measure an illuminance at an illuminated surface (e.g., floor surface) which is illuminated by light from the LED light sources 22A and 22B of the LED unit 2. The supply currents to the respective LED light sources 22A and 22B may be controlled such that the detected illuminance obtained by the illuminance detection unit is substantially kept constant.

The illuminance detection unit (sensor unit) is placed on an outer periphery of a fixture body of a lighting fixture, for example. The illuminance detection unit is designed to measure an illuminance at an area with a diameter of 3 m on a floor surface positioned about 2.4 m from the illuminance detection unit.

When the push button 101 of the remote controller 9 is pushed, the control code (automatic control code) for the automatic dimming control or automatic turning-off control based on outside light is generated. Upon receiving the automatic control code from the remote controller 9, the lighting control unit 6 adjusts the first supply current and the second supply current such that the illuminance measured by the illuminance detection unit is kept a predetermined value.

Accordingly, the lighting device of the present embodiment may include the illuminance detection unit (not shown) configured to measure an illuminance of the illuminated surface illuminated by light from the LED light sources 22. In this arrangement, the lighting control unit 6 controls the supply currents to the respective LED light sources 22 such that the detected illuminance obtained by the illuminance detection unit is substantially kept constant.

In other words, the lighting device of the present embodiment may include the illuminance detection unit (not shown) configured to measure an illuminance at a predetermined area. The lighting control unit 6 is configured to adjust the magnitudes of each of the first supply current and the second supply current such that the illuminance measured by the illuminance detection unit is identical to a predetermined value. For example, the predetermined value is corresponding to an illuminance at the predetermined area in a situation where the luminous flux of the second light emitting element (LED) 222 is equivalent to its rated luminous flux. Alternatively, for example, the predetermined value is corresponding to an illuminance at the predetermined area in a situation where the luminous flux of the first light emitting element (LED) 221 is equivalent to its rated luminous flux. In brief, the predetermined value is appropriately selected based on a desired illuminance.

According to this lighting device, it is possible to substantially keep the illuminance at the illuminated surface (predetermined area) constant. Especially, even when the color of light from the LED unit 2 is changed from the natural white color to the lamp color, the illuminance at the illuminated surface of the lighting device (lighting fixture) is kept substantially constant (predetermined value). Therefore, the lighting control of the LED unit 2 can be made easy. Hence, the illuminance at the desired illuminated surface can be kept substantially constant irrespective of switch of the color temperature of the LED unit 2.

### Second Embodiment

The lighting device of the present embodiment is explained below.

In the lighting device of the first embodiment, as for the LED light source 22B configured to emit light with a color corresponding to the natural white color, when the maximum lighting order is outputted, the output of the LED light source 22B (the luminous flux of the LED 222) is adjusted to its rated luminous flux. As for the LED light source 22A configured to emit light with a color corresponding to the lamp color, when the maximum lighting order is outputted, the output of the LED light source 22A (the luminous flux of the LED 221) is adjusted to be greater than its rated luminous flux. By doing this, the lighting device of the first embodiment reduces a change in the luminous flux between the LED light sources 22A and 22B. In contrast, in the lighting device of the present embodiment, the output of the LED light source 22A (the luminous flux of the LED 221) configured to emit light with a color corresponding to the lamp color is adjusted to its rated luminous flux, and the output of the LED light source 22B (the luminous flux of the LED 222) configured to emit light with a color corresponding to the natural white color is adjusted to be less than its rated luminous flux. By doing this, the lighting device of the present embodiment reduces a change in the luminous flux between the LED light sources 22A and 22B. Note that, the other configurations of the present embodiment are same as those of the first embodiment. The same configurations are designated by the same reference numerals and explanations thereof are deemed unnecessary.

The lighting device of the present embodiment includes the LED unit 2, and the lighting control unit 6 configured to perform lighting control of each of the LED light sources 22 (22A and 22B) of the LED unit 2.

In the lighting device of the present embodiment, the first supply current is equivalent to a current (rated current) that the luminous flux of the LED 221 is identical to its rated luminous flux (about 46 lm). As for the LED light source 22A, the four series circuits of the six LEDs 221 are connected in parallel with each other. Thus, to supply the forward current of 75 mA to each of the four series circuits, the first supply current is selected to be 300 mA.

Each LED unit 2 includes the LED light source 22A constituted by the twenty-four LEDs 221. Thus, the luminous flux (first luminous flux) of the LED unit 2 in the first lighting process is about 1105 lm. Consequently, a total of the luminous flux (first luminous flux) of the four LED units 2 is about 4420 lm.

The second supply current is selected such that the luminous flux (second luminous flux) of the LED unit 2 in the second lighting process is equivalent to the first luminous flux (about 1105 lm) of the LED unit 2 in the first lighting process.

The number of the LEDs 222 of the LED light source 22B is equivalent to the number of the LEDs 221 of the LED light source 22A, and is twenty-four. Hence, the second supply current is selected such that the LED 222 has the luminous flux of about 46 lm. According to aforementioned formula (1), when the forward current x2 is about 67.9 mA, the luminous flux y2 of the LED 222 is about 46 lm. As for the LED light source 22B, the four series circuits of the six LEDs 222 are connected in parallel with each other. Thus, to supply the forward current of about 67.9 mA to each of the four series circuits, the second supply current is selected to be about 271.6 mA.

Each LED unit 2 includes the LED light source 22B constituted by the twenty-four LEDs 222. Thus, the luminous flux (second luminous flux) of the LED unit 2 in the second lighting process is about 1105 lm. Consequently, a total of the luminous flux (second luminous flux) of the four LED units 2 is about 4420 lm.

In brief, the lighting control unit 6 supplies the first supply current of about 300 mA to the series circuit of the four LED units 2 in the first lighting process. Consequently, the luminous flux (first luminous flux) of each of the LED units 2 is about 1105 lm, and the total of the luminous flux of the four LED units 2 is about 4420 lm. In contrast, the lighting control unit 6 supplies the second supply current of about 271.6 mA to the series circuit of the four LED units 2 in the second lighting process. Consequently, the luminous flux (second luminous flux) of each of the LED units 2 is about 1105 lm, and the total of the luminous flux of the four LED units 2 is about 4420 lm.

As mentioned above, the lighting control unit 6 is configured to adjust the first supply current to a magnitude different from the magnitude of the second supply current such that the first luminous flux is identical to the second luminous flux. Especially, in the lighting device of the present embodiment, the first color temperature is lower than the second color temperature. In this case, the lighting control unit 6 is configured to adjust the second supply current to a magnitude lower than the magnitude of the first supply current such that the first luminous flux is identical to the second luminous flux. Further, the first supply current has a magnitude selected such that the luminous flux of the first light emission element (LED) 221 is identical to the rated luminous flux thereof.

The following explanation is made to operation of the lighting device of the present embodiment.

When the push button 105 of the remote controller 9 is pushed, the control code (the maximum lighting order to the LED light source 22B) for changing the dimming and color-adjusting state to the “first state” is inputted into the control unit 63. As a result, the control unit 63 controls the lighting circuit units 61 and 62 in such a manner to adjust the dimming rates of the respective LED light sources 22A and 22B. In brief, the lighting control unit 6 performs the second lighting process.

Concretely, the control unit 63 sets the current (second supply current) outputted from the lighting circuit unit 61 to 271.6 mA in order to turn on the four LED light sources 22B. As a result, the current of 67.9 mA (90.5%) flows through each of the series circuits.

Therefore, according to formula (1), the luminous flux of each one of the LEDs 222 of each of the LED light sources 22B is about 46 lm. Consequently, the total luminous flux of the LED units 2A to 2D each having the twenty-four LEDs 222 is about 4420 lm when the current flowing through each LED 222 is controlled such that the output of each LED 222 is less than the rated luminous flux (90.5%).

Meanwhile, when the push button 106 of the remote controller 9 is pushed, the control code (the maximum lighting order to the LED light source 22A) for changing the dimming and color-adjusting state to the “second state” is inputted into the control unit 63. As a result, the control unit 63 controls the lighting circuit units 61 and 62 in such a manner to adjust the dimming rates of the respective LED light sources 22A and 22B. In brief, the lighting control unit 6 performs the first lighting process.

Concretely, the control unit 63 sets the current (first supply current) outputted from the lighting circuit unit 62 to 300 mA in order to turn on the four LED light sources 22A. As a result, the current of 75 mA (100%) flows through each of the series circuits.

Therefore, according to formula (2), the luminous flux of each one of the LEDs 221 of each of the LED light sources 22A is about 46 lm. Consequently, the total luminous flux of the LED units 2A to 2D each having the twenty-four LEDs 221 is about 4420 lm when the current flowing through each LED 221 is controlled such that the output of each LED 221 is identical to the rated luminous flux.

Accordingly, with performing the aforementioned control, it is possible to make the total luminous flux (second luminous flux) in the first state substantially identical to the total luminous flux (first luminous flux) in the second state. Consequently, it is possible to propose the lighting device which does not give feelings of strangeness to a user when the first state is switched to the second state or the second state is switched to the first state.

Especially, in the lighting device of the present embodiment, the first color temperature is lower than the second color temperature. The first light emission group (LED light source) 22A includes the first light emission element (LED) 221 configured to emit light serving as a dominant component of the light having the first color temperature. The first supply current has a magnitude which is selected such that the luminous flux of the first light emission element (LED) 221 equals to the rated luminous flux of the first light emission element.

Hence, according to the lighting device of the present embodiment, with adjusting the output (luminous flux) of the second light emission element (LED) 222 of the second light emission element group (LED light source) 22B to be less than the rated luminous flux, it is possible to reduce an increase in a temperature of the LED 222 of the LED light source 22B. Thus, a decrease in efficiency due to an increase in the temperature can be suppressed.

### Third Embodiment

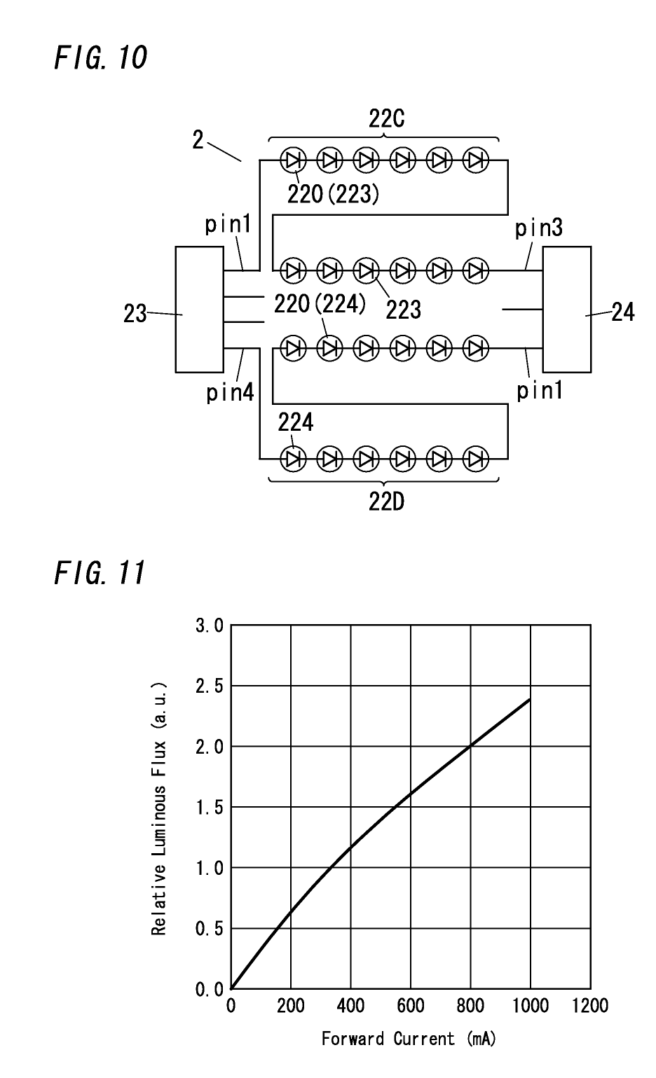

The following explanation referring to FIGS. 10 to 12 is made to the lighting device of the present embodiment.

The lighting device of the present embodiment is different from the lighting devices of the first and second embodiments in the configurations and control methods of the LED light sources 22 (22C and 22D) of the LED unit 2. Note that, the other configurations of the present embodiment are same as those of the first and second embodiments. The same configurations are designated by the same reference numerals and explanations thereof are deemed unnecessary.

The lighting device of the present embodiment includes the LED unit 2, and the lighting control unit 6 configured to perform lighting control of each of the LED light sources 22 (22C and 22D) of the LED unit 2.

FIG. 10 is a circuit diagram illustrating the LED unit 2 in accordance with the present embodiment.

In the present embodiment, the plural light emission elements (LEDs) 220 include two kinds of light emission elements (LEDs) 223 and 224 having mutually different color temperature. For example, as shown in FIG. 10, the light source unit 2 includes the twelve light emission elements (LEDs) 223 and the twelve light emission elements (LEDs) 224.

The light emission element (LED) 223 is configured to emit light having a relatively low color temperature (light with a color corresponding to a lamp color). The light emission element (LED) 224 is configured to emit light having a relatively high color temperature (light with a color corresponding to a natural white color).

In the light source unit 2 of the present embodiment, a series circuit of the twelve light emission elements (LEDs) 223 constitutes the LED light source 22 (22C). Further, a series circuit of the twelve light emission elements (LEDs) 224 constitutes the LED light source 22 (22D).

As mentioned above, the LED light source 22C includes a series circuit formed by connecting in series the twelve LEDs 223 (e.g., “NCSL119A-H1” available from Nichia chemical industries) designed to emit light with a color corresponding to a lamp color with relatively high color rendering properties (general color rendering index: Ra=92). Further, this series circuit has an anode side connected to the first pin pin1 of the connector 23 and has a cathode side connected to the third pin pin3 of the connector 24.

In contrast, the LED light source 22D includes a series circuit formed by connecting in series the twelve LEDs 224 (e.g., “NCW119A-H3” available from Nichia chemical industries) designed to emit light with a color corresponding to a natural white color with relatively low color rendering properties (general color rendering index: Ra=83). Further, this series circuit has an anode side connected to the fourth pin pin4 of the connector 23 and has a cathode side connected to the first pin pin1 of the connector 24.

Also in the present embodiment, like the first embodiment, the four LED units 2A to 2D are connected to the lighting control unit 6 (see FIG. 1). Note that, since the LED units are connected to the lighting control unit 6 in a similar connection manner as the first embodiment, an explanation to such a connection manner is deemed unnecessary.

FIG. 11 shows a graph illustrating a relation between the forward current of the LED 220 (223, 224) of the LED light source 22 (22C, 22D) and relative luminous flux.

When the forward current of 350 mA flows through the LED 224 of the LED light source 22D configured to emit light with a color corresponding to the natural white color, the rated luminous flux is 110 lm. Based on FIG. 11, a relational expression between the luminous flux y4 [lm] of the LED 224 and the forward current x4 [mA] can be calculated and represented by formula (3).

$$\begin{matrix}[ FORMULA 3 ] & \\ y 4 = \frac{11}{40} \cdot x 4 + 13.75 & ( 3 )\end{matrix}$$

When the forward current of 50 mA flows through the LED 223 of the LED light source 22C configured to emit light with a color corresponding to the lamp color, the rated luminous flux is 80 lm. Similarly, a relational expression between the luminous flux y3 [lm] of the LED 223 and the forward current x3 [mA] can be calculated and represented by formula (4).

$$\begin{matrix}[ FORMULA 4 ] & \\ y 3 = \frac{1}{5} \cdot x 3 + 10 & ( 4 )\end{matrix}$$

In the first lighting process, the lighting control unit 6 supplies the first supply current to the first light emission element group of the plurality of the light emission elements 220 such that the light source unit 2 emits light having the first color temperature (in the present embodiment, light having the lamp color). The first light emission element group includes the two LED light sources 22C and 22D. In other words, the first light emission element group includes the light emission element circuit (LED light source) 22C constituted by the LEDs 223 and the light emission element circuit (LED light source) 22D constituted by the LEDs 224. In the first light emission element group, the LED 223 defines the first light emission element configured to emit light serving as a dominant component of the light having the first color temperature.

In the first lighting process, the lighting control unit 6 supplies the first supply currents I1C and I1D to the respective light emission element circuits (LED light sources) 22C and 22D included in the first light emission element group of the plural light emission elements 220, thereby allowing the light source unit 2 to emit light with the first color temperature. In other words, the lighting control unit 6 is configured to, in the first lighting process, supply the first supply current (first main supply current) I1C to the light emission element circuit (LED light source) 22C configured to emit light serving as a dominant component of the light having the first color temperature, and supply the first supply current (first auxiliary supply current) I1D to the light emission element circuit (LED light source) 22D used secondarily.

In the second lighting process, the lighting control unit 6 supplies the second supply current to the second light emission element group of the plurality of the light emission elements 220 such that the light source unit 2 emits light having the second color temperature (in the present embodiment, light having the natural white color). The second light emission element group includes the two LED light sources 22C and 22D. In other words, the second light emission element group includes the light emission element circuit (LED light source) 22C constituted by the LEDs 223 and the light emission element circuit (LED light source) 22D constituted by the LEDs 224. In the second light emission element group, the LED 224 defines the second light emission element configured to emit light serving as a dominant component of the light having the second color temperature.

In the second lighting process, the lighting control unit 6 supplies the second supply currents I2C and I2D to the respective light emission element circuits (LED light sources) 22C and 22D included in the second light emission element group of the plural light emission elements 220, thereby allowing the light source unit 2 to emit light with the second color temperature. In other words, the lighting control unit 6 is configured to, in the second lighting process, supply the second supply current (second main supply current) I2D to the light emission element circuit (LED light source) 22D configured to emit light serving as a dominant component of the light having the second color temperature, and supply the second supply current (second auxiliary supply current) I2C to the light emission element circuit (LED light source) 22C used secondarily.

The second supply current I2D is defined as a current supplied to the second light emission element (LED) 224 configured to emit light serving as a dominant component of the light having the second color temperature. The second supply current I2D has a magnitude selected such that the luminous flux of the LED 224 is identical to its rated luminous flux. The LED light source 22D is the series circuit of the twelve LEDs 224. Hence, to supply the forward current of about 350 mA to the series circuit, the second supply current I2D is selected to be about 350 mA.

The second supply current I2C is defined as a current supplied to the light emission element (LED) 223 used secondarily in the second lighting process. For example, the second supply current I2C has a magnitude selected such that the luminous flux of the LED 223 is identical to its minimum luminous flux. The minimum flux is defined as luminous flux of the LED 223 corresponding to the lower limit of the dimming rate. For example, the minimum luminous flux of the LED 223 is 30 lm, and the forward current corresponding to the minimum luminous flux is about 100 mA. The LED light source 22C is the series circuit of the twelve LEDs 223. Hence, to supply the forward current of about 100 mA to the series circuit, the second supply current I2C is selected to be about 100 mA.

In the second lighting process, the lighting control unit 6 supplies the forward current of about 100 mA to the LED light source 22C and the forward current of about 350 mA to the LED light source 22D. In the second lighting process, the LED light source 22C has the luminous flux of about 360 lm, and the LED light source 22D has the luminous flux of about 1320 lm. Therefore, in the second lighting process, the LED unit 2 has the luminous flux (second luminous flux) of about 1680 lm. Consequently, a total of the luminous flux (second luminous flux) of the four LED units 2 is about 6720 lm.

The first supply current I1D is defined as a current supplied to the light emission element (LED) 224 used secondarily in the first lighting process. For example, the first supply current I1D has a magnitude selected such that the luminous flux of the LED 224 is identical to its minimum luminous flux. The minimum flux is defined as luminous flux of the LED 224 corresponding to the lower limit of the dimming rate. For example, the minimum luminous flux of the LED 224 is 40 lm, and the forward current corresponding to the minimum luminous flux is about 95 mA. The LED light source 22D is the series circuit of the twelve LEDs 224. Hence, to supply the forward current of about 95 mA to the series circuit, the first supply current I1D is selected to be about 95 mA. Therefore, in the first lighting process, the LED light source 22D has the luminous flux of about 480 lm.

The first supply current I1C is defined as a current supplied to the first light emission element (LED) 223 configured to emit light serving as a dominant component of the light having the first color temperature. The first supply current I1C has a magnitude selected such that the luminous flux (first luminous flux) of the LED unit 2 in the first lighting process is identical to the second luminous flux (about 1680 lm) of the LED unit 2 in the second lighting process.

Since the luminous flux of the LED light source 22D in the first lighting process is about 480 lm, the first supply current I1C is selected such that the LED light source 22C has the luminous flux of about 1200 lm. The LED light source 22C has the twelve LEDs 223. It is sufficient that the luminous flux of the LED 223 is about 100 lm. According to formula (4), when the forward current x3 is about 450 mA, the luminous flux y3 of the LED 223 is about 100 lm. The LED light source 22C is the series circuit of the twelve LEDs 223. Hence, to supply the forward current of about 450 mA to the series circuit, the first supply current I1C is selected to be about 450 mA.

Consequently, in the first lighting process, the lighting control unit 6 supplies the forward current of about 450 mA to the LED light source 22C and the forward current of about 95 mA to the LED light source 22D. In the first lighting process, the LED light source 22C has the luminous flux of about 1200 lm, and the LED light source 22D has the luminous flux of about 480 lm. Therefore, in the first lighting process, the LED unit 2 has the luminous flux (first luminous flux) of about 1680 lm. Consequently, a total of the luminous flux (first luminous flux) of the four LED units 2 is about 6720 lm.

In this manner, the lighting control unit 6 adjusts the first supply currents I1C and I1D and the second supply currents I2C and I2D such that the first luminous flux and the second luminous flux have the same magnitude.

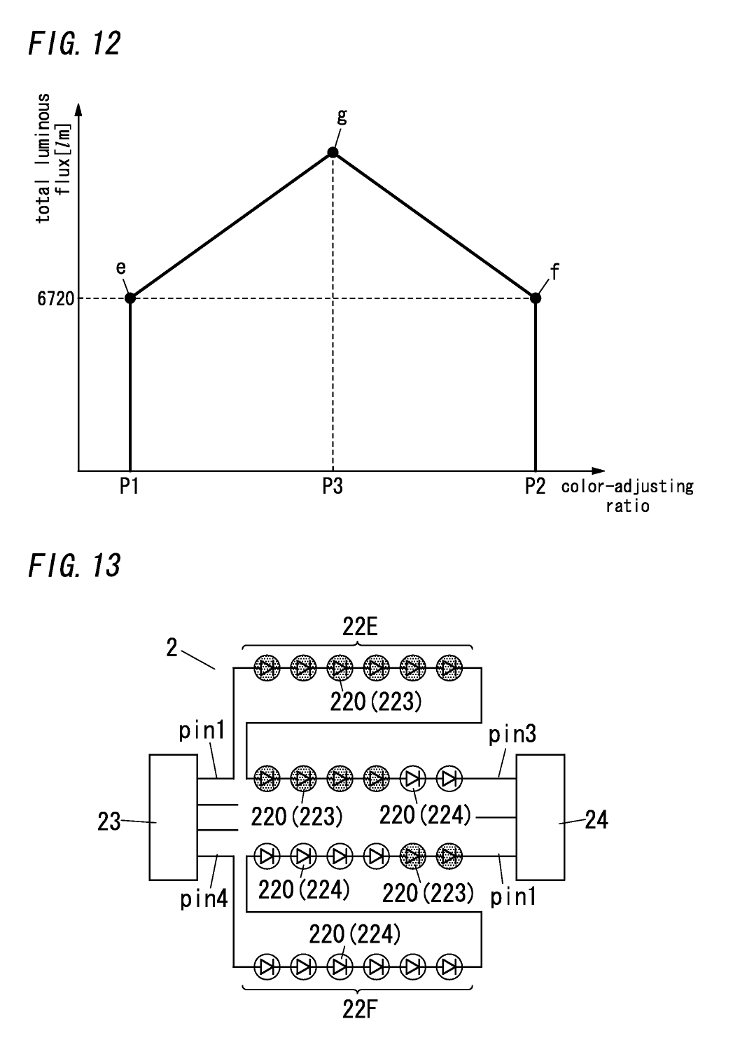

FIG. 12 is a diagram schematically illustrating a relation between the total luminous flux of the LED light sources 22C and 22D and the color-adjusting ratio.

P1 in FIG. 12 represents a state in which the dimming rate of the LED light source 22C is the lower limit (e.g., the dimming rate causing the forward current x3 to be 100 mA) and the dimming rate of the LED light source 22D is 100%. The state represented by P1 is corresponding to a state in which the lighting control unit 6 performs the second lighting process. In brief, in P1, the LED unit 2 emits light with the natural white color. The total of the luminous flux (second luminous flux) of the four LED units 2 is about 6720 lm (see point “e” in FIG. 12).

P2 in FIG. 12 represents a state in which the dimming rate of the LED light source 22C is 100% and the dimming rate of the LED light source 22D is its lower limit (i.e., the dimming rate causing the forward current x4 to be 95 mA). The state represented by P2 is corresponding to a state in which the lighting control unit 6 performs the first lighting process. In brief, in P2, the LED unit 2 emits light with the lamp color. The total of the luminous flux (first luminous flux) of the four LED units 2 is about 6720 lm (see point “f” in FIG. 12).

P3 in FIG. 12 represents a state in which the dimming rate of the LED light source 22C is 100% and the dimming rate of the LED light source 22D is 100% (i.e., the color-adjusting ratio=100:100). In P3, since each of the dimming rates of the LED light sources 22C and 22D is 100%, light emitted from the LED unit 2 is light with the intermediate color. Further, the total luminous flux of the LED unit 2 has a maximum level at P3 (see point “g” in FIG. 12).

The following explanation is made to operation of the lighting device.

When the push button 105 of the remote controller 9 is pushed, the control code (the maximum lighting order to the LED light source 22D) for changing the dimming and color-adjusting state to the “first state” is inputted into the control unit 63. As a result, the control unit 63 controls the lighting circuit units 61 and 62 in such a manner to adjust the dimming rates of the respective LED light sources 22C and 22D. In brief, the lighting control unit 6 performs the second lighting process.

Concretely, the control unit 63 adjusts the current (second supply current I2D) outputted from the lighting circuit unit 61 to 300 mA in order to turn on the four LED light sources 22D. In this regard, according to formula (3), the luminous flux of each one of the LEDs 224 of each of the LED light sources 22D is about 110 lm.

Additionally, the control unit 63 adjusts the current (second supply current I2C) outputted from the lighting circuit unit 62 to 100 mA in order to turn on the LED light source 22C. In this regard, according to formula (4), the luminous flux of each one of the LEDs 223 of each of the LED light sources 22C is about 30 lm (the minimum luminous flux).

Consequently, the total luminous flux of the LED units 2A to 2D is about 6720 lm (=(110 lm*12+30 lm*12)*4) (point “e” in FIG. 12).

Meanwhile, when the push button 106 of the remote controller 9 is pushed, the control code (the maximum lighting order to the LED light source 22C) for changing the dimming and color-adjusting state to the “second state” is inputted into the control unit 63. As a result, the control unit 63 controls the lighting circuit units 61 and 62 in such a manner to adjust the dimming rates of the respective LED light sources 22C and 22D. In brief, the lighting control unit 6 performs the first lighting process.

Concretely, the control unit 63 adjusts the current (first supply current I1C) outputted from the lighting circuit unit 62 to 450 mA in order to turn on the four LED light sources 22C. In this regard, according to formula (4), the luminous flux of each one of the LEDs 223 of each of the LED light sources 22C is about 100 lm.

Additionally, the control unit 63 adjusts the current (first supply current I1D) outputted from the lighting circuit unit 61 to 95 mA in order to turn on the LED light source 22D. In this regard, according to formula (3), the luminous flux of each one of the LEDs 224 of each of the LED light sources 22D is about 40 lm (the minimum luminous flux).

Consequently, the total luminous flux of the LED units 2A to 2D is about 6720 lm (=(100 lm*12+40 lm*12)*4) (point “f” in FIG. 12).

In brief, according to the present embodiment, in the first state, to set the total luminous flux of the four LED units 2A to 2D to about 6720 lm, the output of the LED light source 22D is adjusted to the rated luminous flux, and additionally the LED light source 22C is used as an auxiliary light source. Further, in the second state, to set the total luminous flux of the four LED units 2A to 2D to about 6720 lm, the output of the LED light source 22C is adjusted to be not less than the rated luminous flux (e.g., 128.6%), and additionally the LED light source 22D is used as an auxiliary light source.

Accordingly, it is possible to make the total luminous flux in the first state substantially identical to the total luminous flux in the second state. Consequently, it is possible to propose the lighting device which does not give feelings of strangeness to a user when the first state is switched to the second state or the second state is switched to the first state.

Further, in the first state, the LED light source 22C configured to emit light with a color corresponding to the lamp color is used as the auxiliary light source. Accordingly, it is possible to improve the color rendering properties in contrast to a situation in which only the LED light source 22D is turned on.

Furthermore, in the second state, the LED light source 22D configured to emit light with a color corresponding to the natural white color is used as the auxiliary light source. Accordingly, in contrast to a situation in which only the LED light source 22C is turned on, there is no need to increase the supply current over a necessary level. Hence, it is possible to suppress an increase in the temperature and to improve the reliability.

### Fourth Embodiment

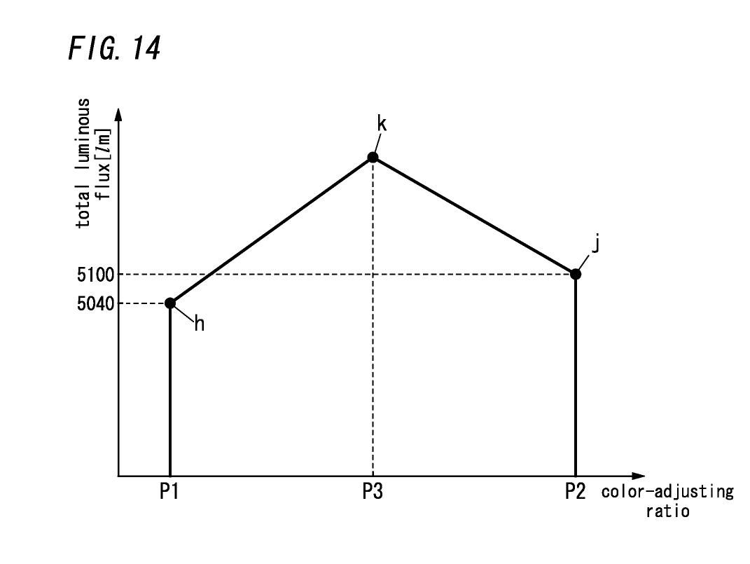

The lighting device of the present embodiment is explained with reference to FIGS. 13 and 14.

The lighting device of the present embodiment is different from the lighting devices of the first to third embodiments in the configurations of the LED light sources 22 (22E and 22F) of the LED unit 2. Note that, the other configurations of the present embodiment are same as those of the first to third embodiments. The same configurations are designated by the same reference numerals and explanations thereof are deemed unnecessary.

The lighting device of the present embodiment includes the LED unit 2, and the lighting control unit 6 configured to perform lighting control of each of the LED light sources 22E and 22F of the LED unit 2.

FIG. 13 is a circuit diagram illustrating the LED unit 2 in accordance with the present embodiment. As shown in FIG. 13, the LED unit 2 includes the twelve light emission elements (LEDs) 223 and the twelve light emission elements (LEDs) 224.

In the light source unit (LED unit) 2 of the present embodiment, a series circuit of the ten light emission elements (LEDs) 223 and the two light emission elements (LED) 224 constitutes the LED light source 22 (22E). Further, a series circuit of the ten light emission elements (LEDs) 224 and the two light emission elements (LED) 223 constitutes the LED light source 22 (22F). Note that, in FIG. 13, in order to distinguish between the LEDs 223 and 224, the LED 223 is shown with a dot pattern.

As mentioned above, the LED light source 22E includes a series circuit formed by connecting in series the ten LEDs 223 and the two LEDs 224. The LED 223 (e.g., “NCSL119A-H1” available from Nichia chemical industries) is designed to emit light with a color corresponding to the lamp color with relatively high color rendering properties (general color rendering index: Ra=92). The LED 224 (e.g., “NCW119A-H3” available from Nichia chemical industries) is designed to emit light with a color corresponding to the natural white color with relatively low color rendering properties (general color rendering index: Ra=83). Further, this series circuit has an anode side connected to the first pin pin1 of the connector 23 and has a cathode side connected to the third pin pin3 of the connector 24.

In contrast, the LED light source 22F includes a series circuit formed by connecting in series the two LEDs 223 and the ten LEDs 224. Further, this series circuit has an anode side connected to the fourth pin pin4 of the connector 23 and has a cathode side connected to the first pin pin1 of the connector 24. Also in the present embodiment, like the first embodiment, the four LED units 2A to 2D are connected to the lighting control unit 6 (see FIG. 1). Note that, since the LED units are connected to the lighting control unit 6 in a similar connection manner as the first embodiment, an explanation to such a connection manner is deemed unnecessary.

In the first lighting process, the lighting control unit 6 supplies the first supply current to the first light emission element group (LED light source) 22E of the plurality of the light emission elements 220 such that the light source unit 2 emits light having the first color temperature (in the present embodiment, light having the lamp color). In the second lighting process, the lighting control unit 6 supplies the second supply current to the second light emission element group (LED light source) 22F of the plurality of the light emission elements 220 such that the light source unit 2 emits light having the second color temperature (in the present embodiment, light having the natural white color).

For example, the second supply current has a magnitude selected such that the luminous flux of the light emission element (LED) 224 configured to emit light serving as a dominant component of the light having the second color temperature is identical to its rated luminous flux (e.g., about 110 lm). The LED light source 22F is the series circuit of the twelve light emission elements (LEDs) 220. Hence, the second supply current is selected to be the rated current (about 350 mA) of the LED 224.

In brief, in the second lighting process, the lighting control unit 6 supplies the forward current of about 350 mA to the LED light source 22F. A total of the luminous flux of the ten LEDs 224 is 1100 lm. According to formula (4), when the forward current x3 is about 350 mA, the luminous flux y3 of the LED 223 is about 80 lm. A total of the luminous flux of the two LEDs 223 is 160 lm. Hence, in the second lighting process, the LED light source 22F has the luminous flux (second luminous flux) of about 1260 lm. Consequently, a total of the luminous flux (second luminous flux) of the four LED units 2 is about 5040 lm.

The first supply current is determined such that the first luminous flux is identical to the second luminous flux (about 1260 lm). The LED light source 22E is the series circuit of the ten LEDs 223 and the two LEDs 224. According to formulae (3) and (4), when I1 denotes the first supply current, the luminous flux (first luminous flux) of the LED light source 22E is given by (51/20) I1+127.5 [lm].

For example, the first supply current is determined such that the luminous flux of the light emission elements (LEDs) 223 configured to emit light serving as a dominant component of light with the first color temperature is identical to predetermined luminous flux (about 100 lm). According to formula (4), when the forward current x3 is about 450 mA, the luminous flux y3 of the LED 223 is about 100 lm.

In brief, in the first lighting process, the lighting control unit 6 supplies the forward current of about 450 mA to the LED light source 22E. A total of the luminous flux of the ten LEDs 223 is 1000 lm. According to formula (3), when the forward current x4 is about 450 mA, the luminous flux y4 of the LED 224 is about 137.5 lm. A total of the luminous flux of the two LEDs 224 is 275 lm. Hence, in the first lighting process, the LED light source 22E has the luminous flux (first luminous flux) of about 1275 lm. Consequently, the total of the luminous flux (first luminous flux) of the four LED units 2 is about 5100 lm.

In this manner, the lighting control unit 6 adjusts the first supply current and the second supply current such that the first luminous flux and the second luminous flux have the same magnitude. Note that, in the present embodiment, the first luminous flux is about 1275 lm, but is not identical to the second luminous flux of about 1260 lm in a strict sense. However, a difference between the first luminous flux and the second luminous flux is about 15 lm, and is about one percentage of the first luminous flux (about 1275 lm). Such a small difference does not cause a feeling of strangeness to a user at the time of switching between the first lighting process and the second lighting process. Thus, it is permissible that the first luminous flux is considered to be identical to the second luminous flux.

FIG. 14 is a diagram schematically illustrating a relation between the total luminous flux of the LED light sources 22E and 22F and the color-adjusting ratio.

P1 in FIG. 14 represents a state in which the dimming rate of the LED light source 22E is the lower limit (e.g., 0%) and the dimming rate of the LED light source 22F is 100%. The state represented by P1 is corresponding to a state in which the lighting control unit 6 performs the second lighting process. In brief, in P1, the LED unit 2 emits light with the natural white color. The total of the luminous flux (second luminous flux) of the four LED units 2 is about 5040 lm (see point “h” in FIG. 14).

P2 in FIG. 14 represents a state in which the dimming rate of the LED light source 22E is 100% and the dimming rate of the LED light source 22F is its lower limit (i.e., 0%). The state represented by P2 is corresponding to a state in which the lighting control unit 6 performs the first lighting process. In brief, in P2, the LED unit 2 emits light with the lamp color. The total of the luminous flux (first luminous flux) of the four LED units 2 is about 5100 lm (see point “j” in FIG. 14).

P3 in FIG. 14 represents a state in which the dimming rate of the LED light source 22E is 100% and the dimming rate of the LED light source 22F is 100% (i.e., the color-adjusting ratio=100:100). In P3, since each of the dimming rates of the LED light sources 22E and 22F is 100%, light emitted from the LED unit 2 is light with the intermediate color. Further, the total luminous flux of the LED unit 2 has a maximum level at P3 (see point “k” in FIG. 14).

The following explanation is made to operation of the lighting device.

When the push button 105 of the remote controller 9 is pushed, the control code (the maximum lighting order to the LED light source 22F) for changing the dimming and color-adjusting state to the “first state” is inputted into the control unit 63. As a result, the control unit 63 controls the lighting circuit units 61 and 62 in such a manner to adjust the dimming rates of the respective LED light sources 22E and 22F. In brief, the lighting control unit 6 performs the second lighting process.

Concretely, the control unit 63 adjusts the current (second supply current) outputted from the lighting circuit unit 61 to 350 mA in order to turn on the four LED light sources 22F. In this regard, according to formula (3), the luminous flux of each one of the LEDs 224 of each of the LED light sources 22F is about 110 lm. Moreover, in this regard, according to formula (4), the luminous flux of each one of the LEDs 223 of each of the LED light sources 22E is about 80 lm. Consequently, the total luminous flux of the LED units 2A to 2D is about 5040 lm (=(110 lm*10+80 lm*2)*4) (point “h” in FIG. 14).

Meanwhile, when the push button 106 of the remote controller 9 is pushed, the control code (the maximum lighting order to the LED light source 22E) for changing the dimming and color-adjusting state to the “second state” is inputted into the control unit 63. As a result, the control unit 63 controls the lighting circuit units 61 and 62 in such a manner to adjust the dimming rates of the respective LED light sources 22E and 22F. In brief, the lighting control unit 6 performs the first lighting process.

Concretely, the control unit 63 adjusts the current outputted from the lighting circuit unit 62 to 450 mA in order to turn on the LED light sources 22E. In this regard, according to formula (4), the luminous flux of each one of the LEDs 223 of each of the LED light sources 22E is about 100 lm. Moreover, in this regard, according to formula (3), the luminous flux of each one of the LEDs 224 of each of the LED light sources 22F is about 137.5 lm. Consequently, the total luminous flux of the LED units 2A to 2D is about 5100 lm (=(100 lm*10+137.5 lm*2)*4) (point “j” in FIG. 14).

In brief, according to the present embodiment, in the first state, to set the total luminous flux of the four LED units 2A to 2D to about 5040 lm, the output of the LED 224 of the LED light source 22F is adjusted to the rated luminous flux, and additionally the LED 223 is used as an auxiliary light source.

Further, in the second state, to set the total luminous flux of the four LED units 2A to 2D to about 5100 lm, the output of the LED 223 of the LED light source 22E is adjusted to be not less than the rated luminous flux (e.g., 128.6%), and additionally the LED 224 is used as an auxiliary light source.

Accordingly, it is possible to make the total luminous flux in the first state substantially identical to the total luminous flux in the second state. Consequently, it is possible to propose the lighting device which does not give feelings of strangeness to a user when the first state is switched to the second state or the second state is switched to the first state.

Additionally, in the aforementioned third embodiment, to use the LED 223 (or the LED 224) with the different luminescent color as the auxiliary light source, it is necessary to control both the LED light sources 22C and 22D. However, in the present embodiment, since the LED light sources 22E and 22F include the LED 223 (or the LED 224) having the different luminescent color, it is sufficient that only one of the LED light source 22E and 22F is controlled. Thus, the control method can be simplified.

Note that, in the lighting devices of the third and fourth embodiments, the magnitude of the second supply current is decided such that the luminous flux of the second light emission element (LED) 224 is equivalent to its rated luminous flux, and the magnitude of the first supply current is decided based on the magnitude of the second supply current (i.e., the second luminous flux of the LED unit 2 determined by the second supply current). However, also in the lighting devices of the third and fourth embodiments, like the second embodiment, the magnitude of the first supply current is decided such that the luminous flux of the first light emission element (LED) 223 is equivalent to its rated luminous flux. In this instance, the magnitude of the second supply current is decided based on the magnitude of the first supply current (i.e., the first luminous flux of the LED unit 2 determined by the first supply current).

### Fifth Embodiment

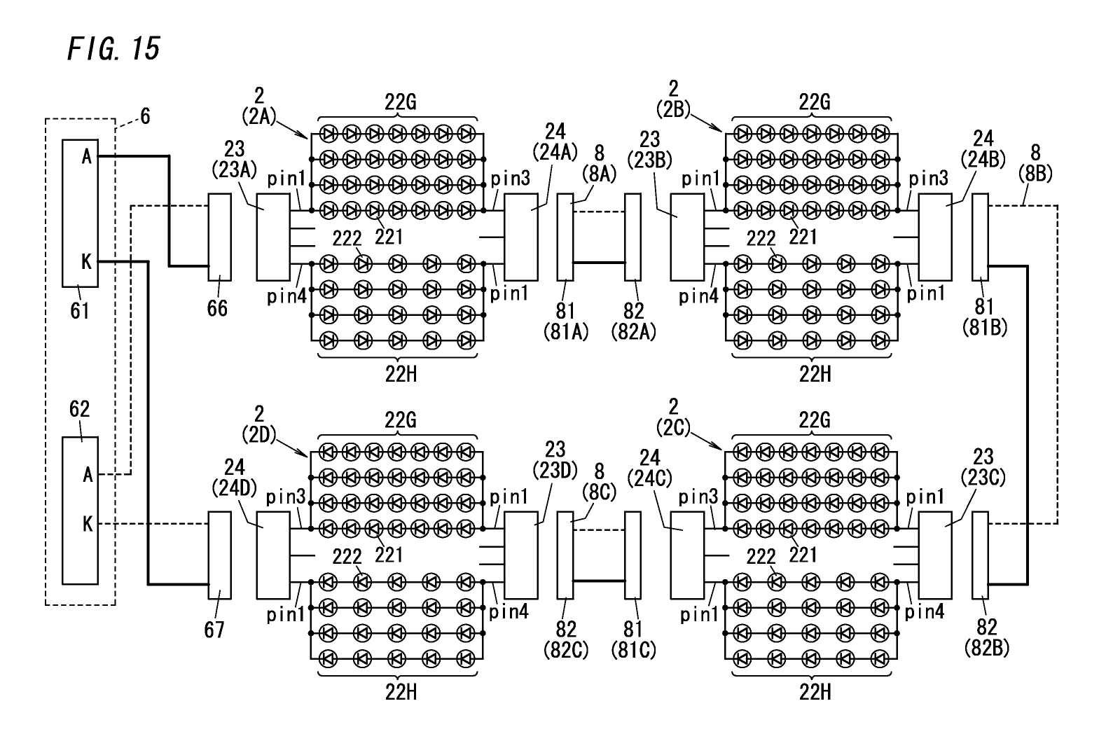

As shown in FIG. 15, the lighting device of the present embodiment includes a plurality of (four, in the illustrated instance) the light source units 2 (2A to 2D) and the lighting control unit 6 configured to control the light source units 2.

The light source unit 2 of the present embodiment includes a plurality of (48, in the illustrated instance) light emission elements (LEDs) 220 having different color temperatures.

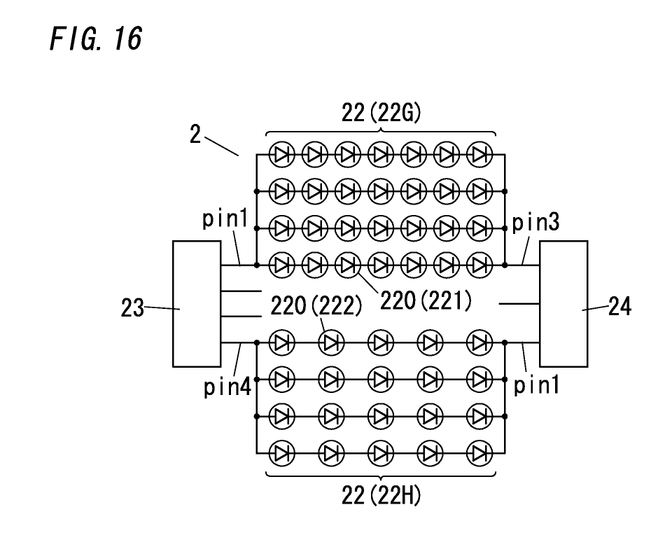

The plural light emission elements (LEDs) 220 include two kinds of light emission elements (LEDs) 221 and 222 having mutually different color temperatures. For example, as shown in FIG. 16, the light source unit 2 includes the twenty-eight (first) light emission elements (LEDs) 221 and the twenty (second) light emission elements (LEDs) 222.

The first light emission element (LED) 221 is configured to emit light having a relatively low color temperature (e.g., light with a color corresponding to the lamp color). The twenty-eight first light emission elements 221 out of the forty-eight light emission elements 220 constitute the light emission element group (first light emission element group) for enabling the light source unit 2 to emit light having a predetermined color temperature (first color temperature). In other words, the first light emission element group includes the first light emission elements (LED) 221 configured to emit light serving as a dominant component of the light having the first color temperature (the color temperature corresponding to the lamp color). Hence, the first light emission element group defines the light source (LED light source) 22 (22G) configured to emit light with the first color temperature.

The second light emission element (LED) 222 is configured to emit light having a relatively high color temperature (e.g., light with a color corresponding to the natural white color). The twenty second light emission elements 222 out of the forty-eight light emission elements 220 constitute the light emission element group (second light emission element group) for enabling the light source unit 2 to emit light having a predetermined color temperature (second color temperature different from the first color temperature). In other words, the second light emission element group includes the second light emission elements (LED) 222 configured to emit light serving as a dominant component of the light having the second color temperature (the color temperature corresponding to the natural white color). Hence, the second light emission element group defines the light source (LED light source) 22 (22H) configured to emit light with the second color temperature.

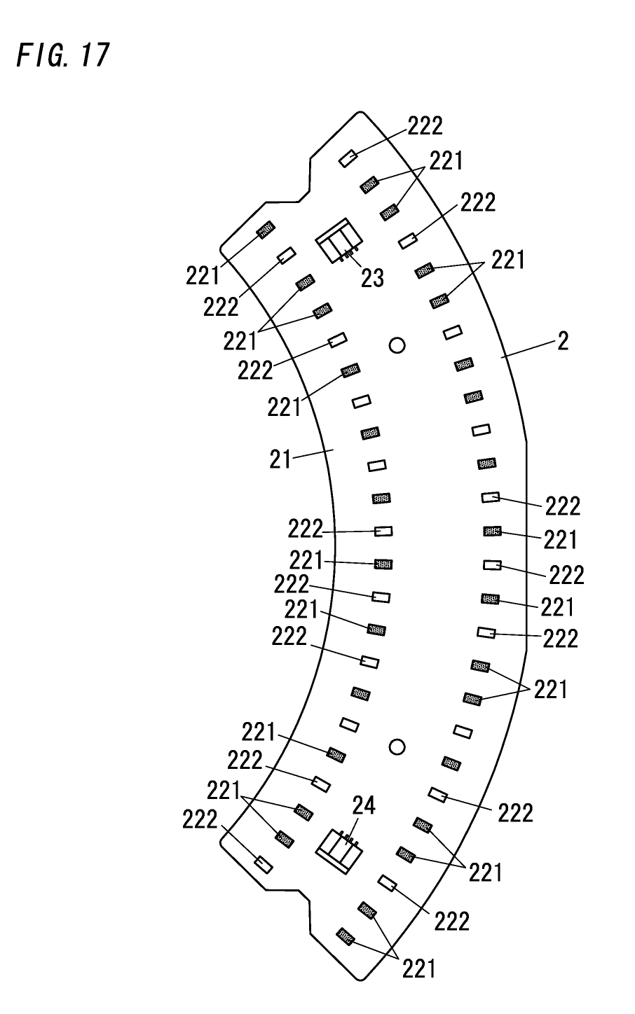

FIG. 17 is an external view (schematic front view) illustrating the LED unit 2. Like the LED unit 2 illustrated in FIG. 5, this LED unit 2 includes the printed board 21, the plurality of the LEDs 220 (221 and 222), and the two connectors 23 and 24. Besides, in FIG. 17, in order to distinguish between the LEDs 221 and 222, the LEDs 221 is shown with a dot pattern.

A plurality of the LEDs 221 and a plurality of the LEDs 222 are mounted on the surface of the printed board 21 such that luminous flux is distributed with uniformity in the surface of the printed board 21 (i.e., the surface of the LED unit 2).

For example, provided to the first side (right side, in FIG. 17) in the lateral direction (width direction) of the surface of the printed board 21 is the light emission element array (first light emission light array) extending along the lengthwise direction of the printed board 21, and provided to the second side (left side, in FIG. 17) in the lateral direction (width direction) of the surface of the printed board 21 is the light emission element array (second light emission light array) extending along the lengthwise direction of the printed board 21.

The first light emission array has a total of the twenty-six LEDs 220 including the sixteen LEDs 221 and the ten LEDs 222. The second light emission array has a total of the twenty-two LEDs 220 including the twelve LEDs 221 and the ten LEDs 222. In the first and second light emission arrays, the LEDs 221 and 222 are arranged alternately in line at regular intervals.

Therefore, according to the LED unit 2 of the present embodiment, luminance at the surface of the LED unit 2 is uniform regardless of the first lighting process or the second lighting process.

Further, the LEDs 221 and 222 are arranged such that the light emission region of the LED unit 2 in the first lighting process is substantially identical to the light emission region of the LED unit 2 in the second lighting process.

For example, as for the LED unit 2 shown in FIG. 17, in the first and second light emission arrays, located on the both sides of the LED 222 are the LEDs 221 and the LEDs 221 are arranged such that the three or more LEDs 221 are not arranged sequentially.

Therefore, switch between the first lighting process and the second lighting process would not cause a substantial change in the light emission region of the LED unit 2. Hence, it is possible to prevent a user from feeling strange.

For example, the lighting control unit 6 is configured to perform the first lighting process and the second lighting process. In the first lighting process, the lighting control unit 6 supplies the first supply current to the first light emission element group (LED light source) 22G of the plurality of the light emission elements 220 such that the light source unit 2 emits light having the first color temperature (in the present embodiment, light having the lamp color). In the second lighting process, the lighting control unit 6 supplies the second supply current to the second light emission element group (LED light source) 22H of the plurality of the light emission elements 220 such that the light source unit 2 emits light having the second color temperature (in the present embodiment, light having the natural white color) different from the first color temperature.

Further, the lighting control unit 6 is configured to adjust the magnitudes of the supply currents in the respective lighting processes such that the light source unit 2 has the same luminous flux (total luminous flux) with regard to the respective lighting processes.

The second supply current is equivalent to a current (rated current) that the luminous flux of the LED 222 is identical to its rated luminous flux (51 to 60.5 lm). As for the LED light source 22H, the four series circuits of the five LEDs 222 are connected in parallel with each other. Thus, to supply the forward current of 75 mA to each of the four series circuits, the second supply current is selected to be 300 mA.

Each LED unit 2 includes the LED light source 22H constituted by the twenty LEDs 222. Thus, the luminous flux (second luminous flux) of the LED unit 2 in the second lighting process is in a range of 1020 to 1210 lm. Consequently, the total of the luminous flux (second luminous flux) of the four LED units 2 is in a range of 4080 to 4840 lm and has a center value of about 4460 lm.

In the lighting device of the present embodiment, the first supply current is equivalent to the second supply current. In brief, the first supply current is 300 mA. As for the LED light source 22G, the four series circuits of the seven LEDs 221 are connected in parallel with each other. Thus, the forward current of 75 mA flows through each of the four series circuits. In this embodiment, a current (rated current) that the luminous flux of the LED 221 is identical to the rated luminous flux (36 to 42.8 lm, in the present embodiment) is 75 mA. That is, the first supply current is equivalent to the rated current of the LED 221.

Each LED unit 2 includes the LED light source 22G constituted by the twenty-eight LEDs 221. Thus, the luminous flux (first luminous flux) of the LED unit 2 in the first lighting process is in a range of 1008 to 1198.4 lm. Consequently, the total of the luminous flux (first luminous flux) of the four LED units 2 is in a range of 4032 to 4793.6 lm and has a center value of about 4410 lm.

As mentioned above, the first light emission element group (LED light source) 22G and the second light emission element group (LED light source) 22H are determined such that the first luminous flux is identical to the second luminous flux when the first supply current and the second supply current have the same magnitude. Further, the lighting control unit 6 is configured to make the first supply current and the second supply current have the same magnitude.

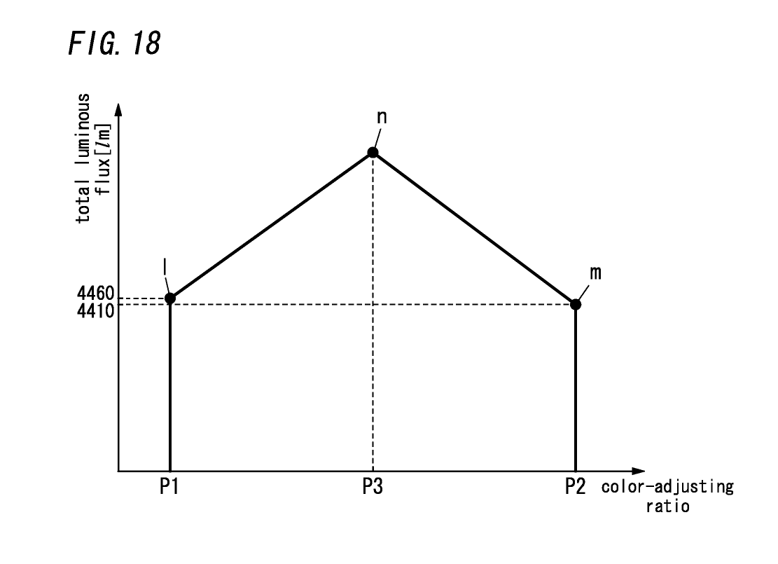

FIG. 18 is a diagram schematically illustrating a relation between the total luminous flux of the LED light sources 22G and 22H and the color-adjusting ratio.

P1 in FIG. 18 represents a state in which the dimming rate of the LED light source 22G is the lower limit (e.g., 0%) and the dimming rate of the LED light source 22H is 100%. The state represented by P1 is corresponding to a state in which the lighting control unit 6 performs the second lighting process. In brief, in P1, the LED unit 2 emits light with the natural white color. The total of the luminous flux (second luminous flux) of the four LED units 2 is about 4460 lm (see point “l” in FIG. 18).

P2 in FIG. 18 represents a state in which the dimming rate of the LED light source 22G is 100% and the dimming rate of the LED light source 22H is its lower limit (i.e., 0%). The state represented by P2 is corresponding to a state in which the lighting control unit 6 performs the first lighting process. In brief, in P2, the LED unit 2 emits light with the lamp color. The total of the luminous flux (first luminous flux) of the four LED units 2 is about 4410 lm (see point “m” in FIG. 18).

P3 in FIG. 18 represents a state in which the dimming rate of the LED light source 22G is 100% and the dimming rate of the LED light source 22H is 100% (i.e., the color-adjusting ratio=100:100). In P3, since each of the dimming rates of the LED light sources 22G and 22H is 100%, light emitted from the LED unit 2 is light with the intermediate color. Further, the total luminous flux of the LED unit 2 has a maximum level at P3 (see point “n” in FIG. 18).

The following explanation is made to operation of the lighting device of the present embodiment.

When the push button 105 of the remote controller 9 is pushed, the control code (the maximum lighting order to the LED light source 22H) for changing the dimming and color-adjusting state to the “first state” is inputted into the control unit 63. As a result, the control unit 63 controls the lighting circuit units 61 and 62 in such a manner to adjust the dimming rates of the respective LED light sources 22G and 22H. In brief, the lighting control unit 6 performs the second lighting process.

Concretely, the control unit 63 adjusts the current (second supply current) outputted from the lighting circuit unit 61 to 300 mA in order to turn on the four LED light sources 22H. In this situation, the current of 75 mA (100%) flows through each of the series circuits.

Therefore, the luminous flux of each one of the LEDs 222 of each of the LED light sources 22H is in a range of 51 to 60.5 lm. Consequently, with adjusting the current flowing through each LED 222 such that the output of each LED 222 is identical to its rated luminous flux, the total luminous flux of the LED units 2A to 2D each including the twenty LEDs 222 is about 4460 lm (point “l” in FIG. 18).

Meanwhile, when the push button 106 of the remote controller 9 is pushed, the control code (the maximum lighting order to the LED light source 22G) for changing the dimming and color-adjusting state to the “second state” is inputted into the control unit 63. As a result, the control unit 63 controls the lighting circuit units 61 and 62 in such a manner to adjust the dimming rates of the respective LED light sources 22G and 22H. In brief, the lighting control unit 6 performs the first lighting process.

Concretely, the control unit 63 adjusts the current (first supply current) outputted from the lighting circuit unit 62 to 300 mA in order to turn on the four LED light sources 22G. In this situation, the current of 75 mA (100%) flows through each of the series circuits.

Therefore, the luminous flux of each one of the LEDs 221 of each of the LED light sources 22G is in a range of 36 to 42.8 lm. Consequently, with adjusting the current flowing through each LED 221 such that the output of each LED 221 is identical to its rated luminous flux, the total luminous flux of the LED units 2A to 2D each including the twenty-eight LEDs 221 is about 4410 lm (point “m” in FIG. 18).

As mentioned in the above, the lighting device of the present embodiment includes: the light source unit (LED unit) 2 including a plurality of the light emission elements (LEDs) 220 (221 and 222) having different color temperatures; and the lighting control unit 6 configured to control the light source unit 2. The lighting control unit 6 is configured to perform: the first lighting process of supplying the first supply current to the first light emission element group (LED light source) 22G of the plurality of the light emission elements (LEDs) 220 such that the light source unit 2 emits light having the first color temperature; and the second lighting process of supplying the second supply current to the second light emission element group (LED light source) 22H of the plurality of the light emission elements (LEDs) 220 such that the light source unit 2 emits light having the second color temperature different from the first color temperature. The lighting control unit 6 is configured to adjust magnitudes of each of the first supply current and the second supply current such that first luminous flux of the light source unit 2 in the first lighting process is identical to second luminous flux of the light source unit 2 in the second lighting process.

Further, in the lighting device of the present embodiment, the first light emission element group (LED light source) 22G and the second light emission element group (LED light source) 22H are determined such that the first luminous flux is identical to the second luminous flux when the first supply current and the second supply current have the same magnitude. The lighting control unit 6 is configured to make the first supply current and the second supply current have the same magnitude.

Furthermore, in the lighting device of the present embodiment, the number of the light emission elements (LEDs) 221 included in the first light emission element group (LED light source) 22G and the number of the light emission elements (LEDs) 222 included in the second light emission element group (LED light source) 22H are determined such that the first luminous flux is identical to the second luminous flux when the first supply current and the second supply current have the same magnitude.

Moreover, in the lighting device of the present embodiment, the first color temperature is lower than the second color temperature. The number of the light emission elements (LEDs) 221 included in the first light emission element group (LED light source) 22G is greater than the number of the light emission elements (LEDs) 222 included in the second light emission group (LED light source) 22H.

The aforementioned lighting device of the present embodiment can reduce a change in the luminous flux due to switch of luminescent color. In other words, there is an advantage in that it is possible to propose the lighting device capable of reducing a change in the luminous flux between the plural kinds of the LED light sources 22 with different luminescent colors and the lighting fixture using the same.

Further, in the lighting device of the present embodiment, when the first supply current and the second supply current have the same magnitude, the first luminous flux is identical to the second luminous flux. Consequently, there is no need to modify the configuration of the lighting control unit 6 for each of the first lighting process (process of controlling the light source unit 2 to emit light with the lamp color) and the second lighting process (process of controlling the light source unit 2 to emit light with the natural white color). In brief, the configuration of the lighting circuit unit 60 of the lighting control unit 6 can be common to the plural lighting process. Hence, the plural lighting circuit units 60 can be constituted by use of the same parts, and the reliability of the lighting control unit 6 can be improved.

Note that, a shape of the LED unit 2; a kind, the number, and arrangement of the LEDs 220; and configurations and control methods of the lighting control unit 6 are not limited to those described in the aforementioned first to fourth embodiments. Different configurations can be adopted so long as total luminous flux is not varied between plural kinds of LED light sources emitting light having different color temperatures.

### Sixth Embodiment

The lighting fixture of the present embodiment includes the lighting device explained in the first to fifth embodiments and a fixture body 1 configured to hold the lighting device.

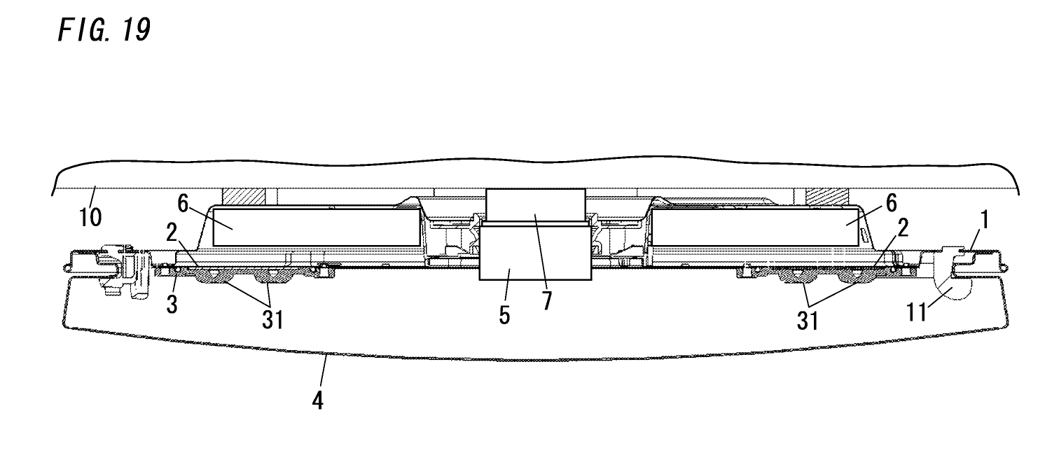

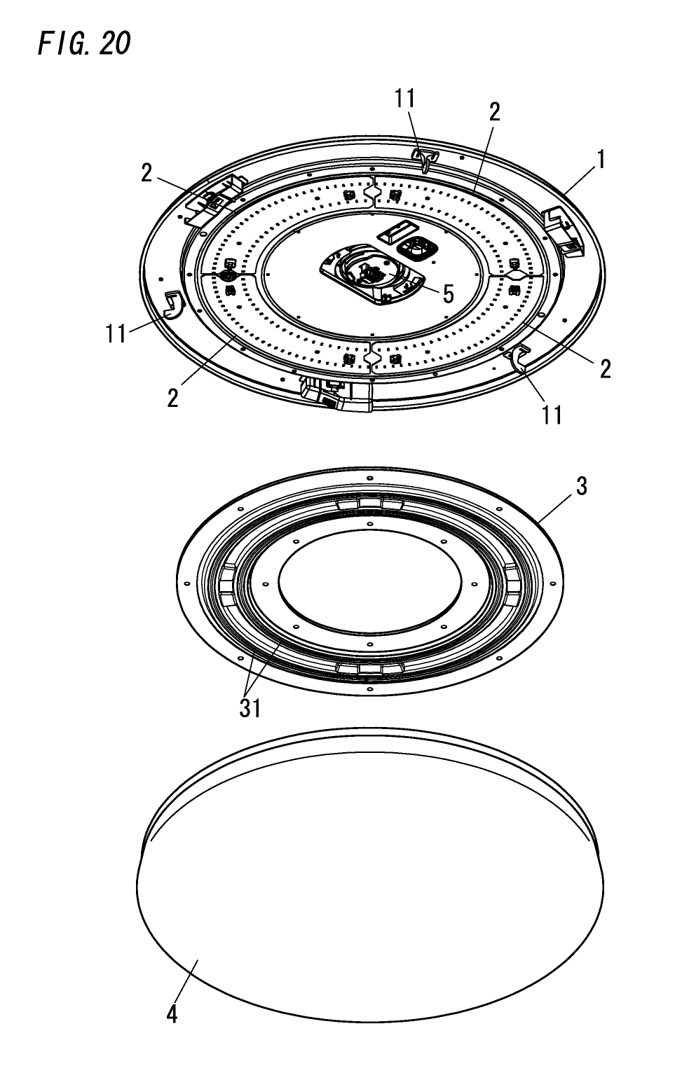

The following explanation referring to FIGS. 19 and 20 is made to the embodiment of the lighting fixture employing the lighting device explained in the first to fifth embodiments.

The lighting fixture of the present embodiment is detachably attached to a ceiling-mounted hooking receptacle 7, thereby being mounted on a ceiling surface 10. This lighting fixture is a lighting fixture which is, generally, referred to as a ceiling light. Note that, the lighting fixture of the present embodiment is not limited to a ceiling light but may be another lighting fixture.

As shown in FIGS. 19 and 20, the lighting fixture includes the fixture body 1, a power supply unit 5, the four LED units (light source units) 2, a light distribution panel 3, and a cover 4 as primary components.

The fixture body 1 is formed into a circular disk shape by use of a metal plate. The power supply unit 5 which is electrically and mechanically connected to the ceiling-mounted hooking receptacle 7 in a detachable manner is arranged on a center of the fixture body 1.

Besides, the four LED units 2 are mounted on a lower surface of the fixture body 1 in such a manner to be arranged in a circumferential direction centered on the power supply unit 5 (see FIG. 20).

The light distribution panel 3 is formed into a circular ring shape by use of transparent synthetic resin (e.g., acrylic resin and polycarbonate resin). The light distribution panel 3 is fixed to the fixture body 1 so as to cover lower surfaces of the four LED units 2. Further, the light distribution panel 3 is integrally provided with optical parts (lenses) 31 for controlling distribution of light emitted from LEDs at its portions opposite to the respective LEDs

The cover 4 is formed into a flat and circular hollow cylindrical shape with an upper surface having an opening, by use of transparent synthetic resin (e.g., acrylic resin and polycarbonate resin). The cover 4 is detachably attached to the lower surface of the fixture body 1 so as to accommodate the LED units 2 and the light distribution panel 3 therein, for example. In this attachment process, a plurality of (three, in FIG. 20) catch pieces 11 provided to an outer periphery of the fixture body 1 catches a vicinity of the opening of the cover 4. By doing so, the cover 4 is attached to the fixture body 1.

As shown in FIG. 19, the lighting control units 6 constituting the aforementioned lighting device are arranged in a periphery of the power supply unit 5 on an upper surface of the fixture body 1. The lighting control unit 6 receives power from the commercial AC power source 20 when connected to the power supply unit 5 via a power supply cable (not shown).

As mentioned above, the lighting fixture of the present embodiment includes the lighting device defined by any one of the first to fifth embodiments and the fixture body 1 configured to hold the lighting device.

Hence, according to the lighting fixture of the present embodiment, with employing the lighting device of any one of the aforementioned first to fifth embodiments, it is possible to propose the lighting fixture which gives no feelings of strangeness to a user.

1. A lighting device comprising:
a light source unit including a plurality of light emission elements having different color temperatures; and
a lighting control unit configured to control the light source unit,
wherein
the lighting control unit is configured to perform:
a first lighting process of supplying a first supply current to a first light emission element group of the plurality of the light emission elements such that the light source unit emits light having a first color temperature; and
a second lighting process of supplying a second supply current to a second light emission element group of the plurality of the light emission elements such that the light source unit emits light having a second color temperature different from the first color temperature, and
the lighting control unit is configured to adjust magnitudes of each of the first supply current and the second supply current such that first luminous flux of the light source unit in the first lighting process is identical to second luminous flux of the light source unit in the second lighting process, and
the first color temperature is lower than the second color temperature, and
the first supply current has a magnitude which is selected such that luminous flux of a first light emission element which is included in the first light emission group and is configured to emit light serving as a dominant component of the light having the first color temperature equals to rated luminous flux of the first light emission element, or the second supply current has a magnitude which is selected such that luminous flux of the second light emission element which is included in the second light emission group and is configured to emit light serving as a dominant component of the light having the second color temperature equals to rated luminous flux of the second light emission element.

2. The lighting device as set forth in claim 1, wherein
the lighting control unit is configured to adjust the first supply current to a magnitude different from the magnitude of the second supply current such that the first luminous flux is identical to the second luminous flux.

3. The lighting device as set forth in claim 2, wherein:
the first color temperature is lower than the second color temperature; and
the lighting control unit is configured to adjust the second supply current to a magnitude lower than the magnitude of the first supply current such that the first luminous flux is identical to the second luminous flux.

4. The lighting device as set forth in claim 3, wherein
the number of the light emission elements included in the first light emission element group and the number of the light emission elements included in the second light emission element group are determined such that the first luminous flux is less than the second luminous flux when the first supply current and the second supply current have the same magnitude.

5. The lighting device as set forth in claim 4, wherein
the number of the light emission elements included in the first light emission element group is identical to the number of the light emission elements included in the second light emission element group.

6. The lighting device as set forth in claim 1, wherein:
the first light emission element group and the second light emission element group are determined such that the first luminous flux is identical to the second luminous flux when the first supply current and the second supply current have the same magnitude; and
the lighting control unit is configured to make the first supply current and the second supply current have the same magnitude.

7. The lighting device as set forth in claim 6, wherein
the number of the light emission elements included in the first light emission element group and the number of the light emission elements included in the second light emission element group are determined such that the first luminous flux is identical to the second luminous flux when the first supply current and the second supply current have the same magnitude.

8. The lighting device as set forth in claim 7, wherein:
the first color temperature is lower than the second color temperature; and
the number of the light emission elements included in the first light emission element group is greater than the number of the light emission elements included in the second light emission group.

9-10. (canceled)

11. The lighting device as set forth in claim 1, further comprising:
an illuminance detection unit configured to measure an illuminance at a predetermined area,
wherein the lighting control unit is configured to adjust the magnitude of each of the first supply current and the second supply current such that the illuminance measured by the illuminance detection unit is identical to a predetermined value.

12. A lighting fixture comprising:
the lighting device defined by claim 1; and
a fixture body configured to hold the lighting device.
